(19) United States
(12) Patent Application Publication
(10) Pub. No.: US 2023/0069247 A1
(43) Pub. Date: Mar. 2, 2023

(54) DATA SHARING SOLUTION

(71) Applicant: CGI Technologies and Solutions Inc., Fairfax, VA (US)

(72) Inventors: Sergey Kucherov, Aurora, IL (US); Kristen Marie Leone, Austin, TX (US); Jennifer Lynn Eschle, Abingdon, VA (US)

(21) Appl. No.: 17/890,940

(22) Filed: Aug. 18, 2022

Related U.S. Application Data
(60) Provisional application No. 63/234,641, filed on Aug. 18, 2021.

(51) Int. Cl. G06F 16/955; G06F 16/951; G06F 16/18

(52) U.S. Cl. CPC G06F 16/955; G06F 16/951; G06F 16/1865

(57) ABSTRACT

A method for secure data sharing includes creating uniform resource identifiers associated with a dataset. The method also includes generating and storing data access permissions for the dataset in an immutable decentralized ledger with a distributed ledger technology, creating a metadata describing the dataset and enabling access to the metadata via uniform resource identifiers, receiving a request from a client device to access a data subset associated with the dataset, verifying a digital credential of the client device using a secure authentication method, authorizing the request and confirming that the client device has a permission to access the dataset based on the distributed ledger technology, and providing multiple instructions and keys to the client device to access and retrieve the data subset. A system including a memory storing instructions and a processor configured to execute the instructions to cause the system to perform the above method are also provided.

### CROSS-REFERENCE TO RELATED APPLICATIONS

The present disclosure is related and claims priority under 35 USC § 119(e) to U.S. Prov. Appln. No. 63/234,641, entitled DATA SHARING SOLUTION, to Jennifer L. ESCHLE, et-al. filed on Aug. 18, 2021, the contents of which are hereby incorporated by reference in their entirety, for all purposes.

### BACKGROUND

### Field

The present disclosure is related to methods and systems for providing a secure environment for sharing data among multiple data aggregators and owners in a computer network in a manner that is easily accessible and standardized for all participants without creating conflicts and redundancies.

### Related Art

In current computer network technology, there are multiple instances of data redundancies and conflicts between two or more databases. This is particularly notorious when the data is associated with individuals (e.g., financial and consumer data networks, health data networks, and the like). Additionally, a standard data transport layout does ensure context and terminology is standardized. There is a lack of trust among different participants about sharing data, especially when the data includes sensitive private information about one or more individuals. Even in cases where two or more service providers decide to share data with one another, there remains the issue of how trustworthy each service provider is about the validity, veracity, and aging of the data shared by the other service provider. Accordingly, there is a need to have a trusted mechanism for a data sharing network amongst multiple service providers that can guarantee data security and the exposure of the latest version of the data for all participants to access, update, and collaborate on.

### BRIEF DESCRIPTION OF THE DRAWINGS

FIGS. 1A-1C illustrate network architectures used in data sharing solutions as disclosed herein, according to some embodiments.

FIGS. 2A-2B illustrate block diagrams of devices and components used in the network architectures of FIGS. 1A-1C, according to some embodiments.

FIGS. 3A-3D illustrate examples of secure networks for data sharing, according to some embodiments.

FIGS. 4A-4C illustrate more examples of secure networks and data sharing chains, according to some embodiments.

FIG. 5 illustrates client back-end systems for client devices in a data sharing network, according to some embodiments.

FIG. 6 is a flow chart illustrating a method for providing a secure system for data sharing, according to some embodiments.

FIG. 7 is a flow chart illustrating a method for providing a secure system for data sharing, according to some embodiments.

FIG. 8 is a flow chart illustrating a method for providing a secure system for data sharing, according to some embodiments.

FIG. 9 is a flow chart illustrating a method for data sharing using a distributed network technology, according to some embodiments.

FIG. 10 is a flow chart illustrating a method for providing a requested data to a client device using a digital credential, according to some embodiments.

FIG. 11 is a flow chart illustrating a method of forming an anonymized graph of relationships in a distributed ledger network, according to some embodiments.

FIG. 12 is a block diagram illustrating an example computer system with which the client and server of FIGS. 1 and 2 and the methods of FIGS. 6-11 can be implemented, according to some embodiments.

In the figures, elements having the same or similar reference numerals have the same or similar attributes, unless explicitly indicated otherwise.

### SUMMARY OF EMBODIMENTS

Methods as disclosed herein for data discovery, share, secure, transform, and manage network information and data transport in the solution and differentiate it from existing data sharing solutions. Some of the distinguishing features include:
a. Utilization of uniform resource identifiers (URI) to create datapoints. The URI datapoints allow for data discovery.
b. Building on the URI data endpoints, implementation of function and query data points that derive data from the original datapoints. This will create a global network of derivative data resulting from a transformation of data received from other data sources.
c. Data Sharing Endpoint (DSE): A data sharing endpoint (DSE) is a server or group of servers that allow clients to access data using open protocol. The DSE includes unique security keys that control access to its data. A DSE can be created, on demand, by any network participant. In some embodiments, a DSE is created on-demand and destroyed after a predetermined period of time (e.g., lifespan). There are several routes to create a DSE including (but not limited to) creating a virtual machine (VM) creating a container, or creating a serverless application.
d. Utilization of smart contracts and distributed ledger technology to enable a secure and immutable ledger of the access controls and transactions.
e. Integration of agnostic translation, context, and unique identification. Standardization of a data transport format or mechanism does not ensure standardization of content. Context and terminology are desirably preserved.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein should be considered within the scope of features and other embodiments illustrated in the figures.

Organizations with similar or complimentary data are likely to have an interest in each other's data. However, the actual sharing of data among organizations and even intra-organizational can be restricted by active attempts to ‘information block.’ Information blocking can be caused by many factors, such as loss of data control/ownership, loss of competitive advantage, another organization benefitting from ‘your’ data, high costs for hosting and maintenance of a solution, and no or limited access to the ‘owner's’ data store. Moreover, traditional approaches to data sharing, such as data warehouses, may expose the hosting or participating organizations to security risks when data from multiple sources is shared in a common database environment or data is in motion/not at rest. Embodiments as disclosed herein address these issues by establishing a secure data sharing environment, in which each organization maintains control of its own data, has access to data (as agreed upon by network governance), shares on a need to know, not need to have basis, permitted accesses are defined by role-based access controls, all data access requests, permitted or denied, are securely and immutably logged via a blockchain, and data can be made available to the requestor in a secure, isolated container (e.g., a DSE), to be available only for the duration authorized by the data owner. This approach maintains each organization's ownership of data and provides a sustained audit trail of all accesses and/or access attempts. In some embodiments, an audit trail includes a log file in a blockchain network, used as a proof of transactions (as sharing, uploading, and downloading data) and a state. Physical location of an organization's data is rarely exposed to a partner or exposed to a partner under clear and strict constraints and conditions.

To resolve the above technical problems arising in the technical field of computer networks, this disclosure provides a secure platform on which multiple organizations/entities can share data as permitted under specific role-based access controls, enabling sharing of data while keeping the ownership of the data intact—meaning, there is no data warehouse/consolidated data structure housing aggregated data sets. The data sharing environment provides an immutable audit trail maintained in blockchain, including a complete list of all data access requests (successful or failed) while ensuring data security through encryption, authorization, and access-control mechanisms. Some embodiments provide flexible data access and sharing within and between entities and simplifies implementation by replacing conventional bi-directional data sharing contracts with “smart contracts” that control the parameters under which data may be accessed. Information and context are maintained via terminology and cataloguing techniques applied to the standard network data transmission protocol. Data security is enhanced by utilization of blockchain to maintain a secure and immutable log of data accesses and attempts, and by the use of role-based security governing all transactions. This presents significant security advantages over traditional data warehouses, which typically lack such precise access control and audit trail capabilities. It likewise provides for greatly enhanced security for personal data, keeping it under the owner's control.

Moreover, embodiments as disclosed herein allow access by individuals to data specific to themselves and allow the individuals to add/modify/delete data that they may share with selected organizations or entities as they choose. Any such individually contributed data will be isolated in a secure container, e.g., a personal datapoint, or a virtual location for data in a network, accessed via a URI by the individual and other specifically authorized individuals or entities. In some embodiments, the ownership of the container is depersonalized, e.g., identified only by a unique ID associated with the user, not by name or other externally identifiable data. In some embodiments, a personal datapoint may be configured with functionality to enable individuals to add data. This functionality within the personal datapoint allows users to provide consent/authorization for other users on the network to access content in the personal datapoint. Such data will remain in a secure, anonymized container under the control of the user, who may add, modify, or delete it at will, and specify by whom and under what conditions it may be read.

Embodiments as disclosed herein create a secure and configurable data sharing platform which is scalable and readily adaptable to new data sources and/or exchanges, and in which the platform itself has no ownership of the data. Control of the data remains with its owners. In some embodiments, a platform includes permanent data storage with the necessary reference data (e.g., metadata) to establish common linkages (common identifiers) between data from the various entities. When desired, the platform may also host storage of extracted data provided by the member organizations (especially useful for large data sets), but each organization's data may be kept in a separate data store. There will be provisions to dynamically ‘transform’ or ‘translate’ the data format from the source format into the one recognized by the destination. Embodiments as disclosed herein provide further advantages by consolidating data views from disparate sources within multiple organizations.

In some embodiments, access to data may be defined by role-based access-control mechanisms, which allows or disallows access requests as they occur based on access-control restrictions defined by the data. Small, ad hoc data requests for single or few records may be returned to the requestor's portal screen. Large-volume data requests (e.g., a data scientist retrieving data for analytics) may be presented to the requestor in a secure container, accessible only to that requestor, and which will exist only for the duration permitted by the data owner.

In some embodiments, individual users may also be able to view data specific to themselves, and which member organizations and service providers may have. Accordingly, ad hoc data requests may be displayed on the portal of member organizations for such individuals who may desire access to personal data and records.

Embodiments of a data sharing network as disclosed herein may find application in several industries, such as Health Care, to assess social determinants of health data by sharing information between large data aggregators who otherwise are unwilling to exchange data. For mobile device management (MDM) platforms, a data sharing network as disclosed herein may be highly desirable to guarantee status updates, metadata, and other information to remain private and yet accessible for legitimate technical purposes. For insurance providers, a payer claims database may operate within a data sharing network, according to embodiments disclosed herein.

In some embodiments, a datapoint in a data sharing network as disclosed herein is a virtual location for a particular dataset. Datapoints are identified by a URI such as data://domain/path/. A datapoint is uniquely identified by a network address. Accordingly, moving data from one physical location to another does not automatically create a new datapoint; rather, the datapoint metadata is updated to reflect the new physical location. In some embodiments, the same dataset is copied to multiple physical places. All these places are described by a single datapoint.

More generally, embodiments as disclosed herein are desirable for sharing sensitive data among many organizations, where gains can be made to: Increase operational efficiency for the public and providers/staff; allow for longitudinal views of data across organizations which increase the value of the data for data scientists and bio-statisticians; provide public access to data currently stored and managed by multiple data aggregators—avoiding the need to go to each aggregator individually to access their own data; and to provide a public datapoint to enable the public to control their own data including consent/authorization and content control. In some embodiments, to avoid the complex overhead of a blockchain, some embodiments include functionalities akin to a transaction-logging mechanism.

Some embodiments include a new type of network monetization such as shareable tokens that are used as virtual payment or incentive for data consumption. The tokens may be automatically transferred from data consumer to data provider every time the consumer retrieves the new portion of the data. According to some embodiments, participants in such a data sharing network may define the monetary value of each token, the method by which they get allocated, and how they get cashed in. In some embodiments, a shareable token has a fungible value associated with a data sharing and transformation operation. System transactions can be associated with work and resources used by the participants to complete them. Accordingly, in some embodiments, the system embeds this information into immutable ledger records in a blockchain for later use in calculating values for settlements between interested parties (e.g., a data provider and a data receiver, via a smart contract). In some embodiments, shareable tokens are automatically transferred from data consumer to data provider when the consumer retrieves a new portion of data. Members of a data sharing network as disclosed herein provide infrastructure and software for other parties to access the data. In general, data providers transfer value to data consumers, which may be recouped using the shareable tokens as a virtual currency. Thus, a data consumption event can be associated with a certain number of shareable tokens transferred from the consumer to the provider. Such embodiments generate virtual currency and create mechanisms for automatic settlement of transactions and/or disputes and the like, between participants.

### General Overview

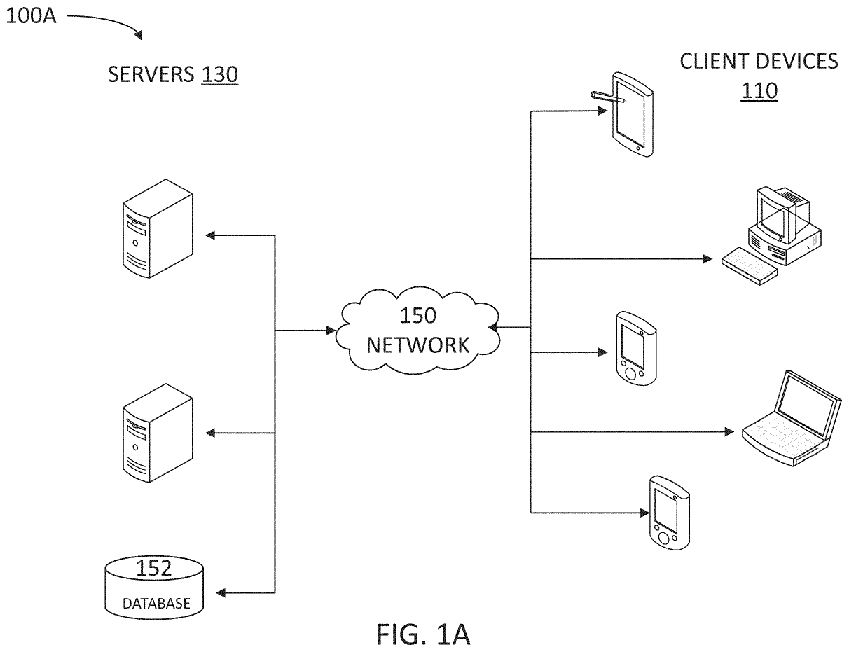

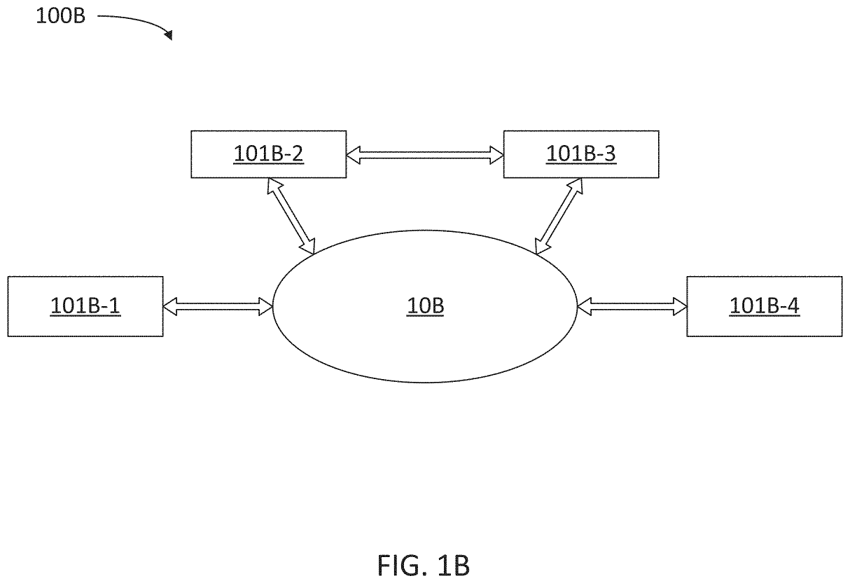

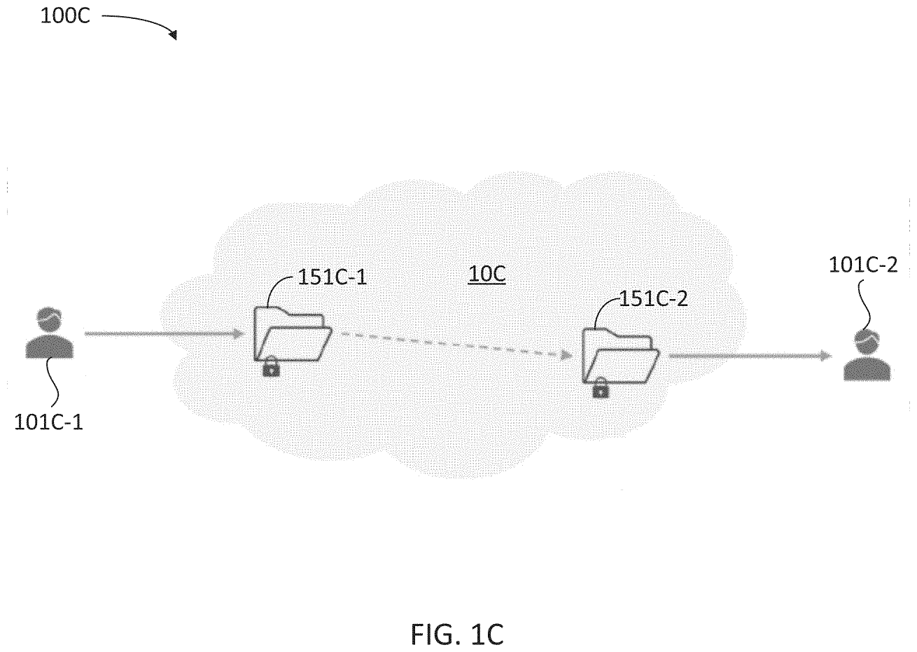

FIGS. 1A-1C illustrate network architectures 100A, 100B, and 100C (hereinafter, collectively referred to a “architectures 100”) used in data shared solutions as disclosed herein, according to some embodiments.

FIG. 1A illustrates architecture 100A for a secure data sharing network, according to some embodiments. Architecture 100A includes servers 130, client devices 110, and at least one database 152, communicatively coupled with each other through a network 150. Servers 130 and client devices 110 have a memory, including instructions which, when executed by a processor, cause servers 130 and client devices 110 to perform at least some of the steps in methods as disclosed herein. In some embodiments, architecture 100A is configured to securely store data from a variety of users and make it available to other users in network 150. The users may have access to one or more client devices 110 to upload and download specific datasets onto or from one or more servers 130, or database 152. In some embodiments, a user of one of client devices 110 is a patient in a medical healthcare network, or a client of a financial institution. Likewise, one or more servers 130 may be part of a financial institution or healthcare provider.

Servers 130 and database 152 may include any device having an appropriate processor, memory, and communications capability for hosting a history log of data storage events. Servers 130 may include a data sharing engine and a web portal engine, to support a secure data sharing. The data sharing and web portal engines may be accessible by various client devices 110 over network 150. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the creative media engine and the history log on one or more of servers 130.

Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like. In some embodiments, network 150 may include a blockchain network having public ledgers powered by key encryption protocols, as disclosed herein. Accordingly, users of client devices 110 may access an immutable ledger in the blockchain network via a private key (e.g., through a smart contract), for loading or downloading datasets.

FIG. 1B is an architecture 100B illustrating different parties and systems 101B-1, 101B-2, 101B-3, and 101B-4 (hereinafter, collectively referred to as “parties 101B”) that may use and interact with a data sharing system 10B, as disclosed herein. Parties 101B may include multiple organizations desirous to secure data sharing with each other and with individuals, who in turn may access and control their own information (e.g., medical records, financial records, business records, and the like). In some embodiments, parties 101B may include players in a network as disclosed herein such as data scientists requesting access to aggregated data to perform statistical analysis as a service, or for a peer-reviewed publication, and the like. Parties 101B may use one or more of client devices 110 described in architecture 100A, and data sharing system 10B may include one or more servers 130, databases 152, and other storage units as disclosed above in relation to architecture 100A.

FIG. 1C illustrates a data sharing system 10C, a data provider 101C-1, and a data consumer 101C-2 (hereinafter, collectively referred to as “data providers 101C”), according to some embodiments. Data provider 101C-1 uploads data onto an entry datapoint 151C-1, which has a public URI that anyone in the public can use to discover and request access. In some embodiments, data providers 101C may use a DSE as an intermediate to upload or download data. An alternative implementation may allow data providers 101C to upload or download data directly. After some internal filtering or transformation, the data is transmitted to a derivative datapoint 151C-2, wherein data consumer 101C-2 can retrieve the transformed or filtered data, provided an access credential is verified by data sharing system 10C. Derivative datapoint 151C-2 includes a value or content calculated from other datapoints (e.g., calculated from other datapoints, e.g., entry datapoint 151C-1). Derivative datapoint 151C-2 can use a single or multiple entry datapoints 151C-1 as a data source (e.g., a “parent datapoint”). A parent datapoint may be either a private, a public, or another derivative datapoint. Derivative datapoint 151C-2 can execute calculations (e.g., transformations) either immediately after entry datapoint 151C-1 has changed, or later, when someone requested permission to download data from derivative datapoint 151C-2.

Datapoint 151C-1 is described by metadata that combines information on the data source, its location, method of access, content, data format, and version. The datapoint metadata describes updates to datapoint 151C-1, both made in the past and in the future. For example, datapoint 151C-1 may include historical information about the weather in Illinois. Even if the associated metadata is updated every day, datapoint 151C-1 and its URI address do not change. For example, historical information about the weather in Chicago may be stored in a datapoint other than 151C-1, even though it is a subset of the Illinois data. Accordingly, metadata associated with datapoint 151C-1 may direct to the datapoint listing historical information about the weather in Chicago.

Derivative datapoint 151C-2 may include most of the fit-for-purpose data produced as a result of a transformation of data received from other data sources (e.g., data provider 101C-1). The metadata of derivative datapoint 151C-2 may include a list of addresses of parent datapoints (e.g., datapoint 151C-1). The metadata also describes the transformation method (e.g., a function) and contains instructions for data processing (for example, source code in a particular language, pseudo-code, mathematical function, and the like). Datapoints 151C-1 and 151C-2 will be collectively referred to, hereinafter, as “datapoints 151C.”

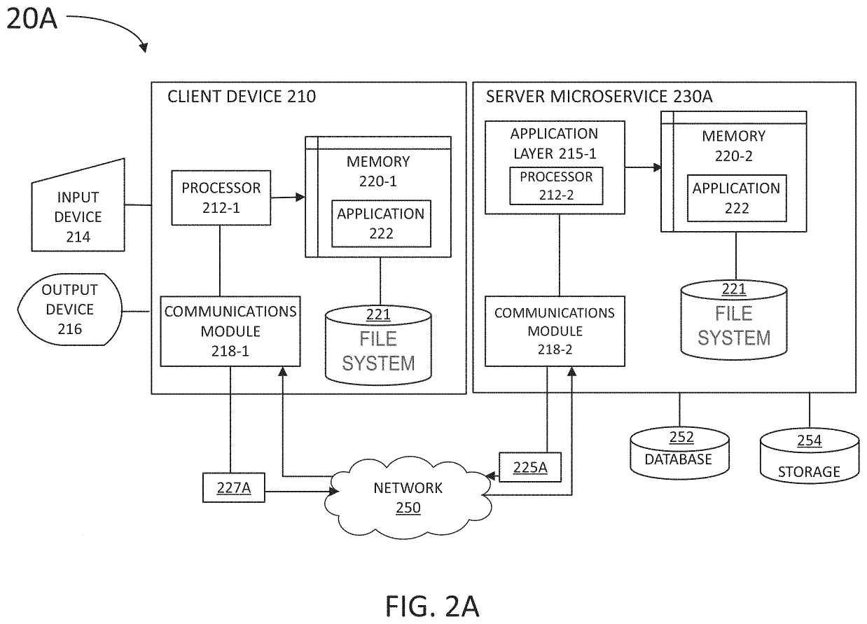

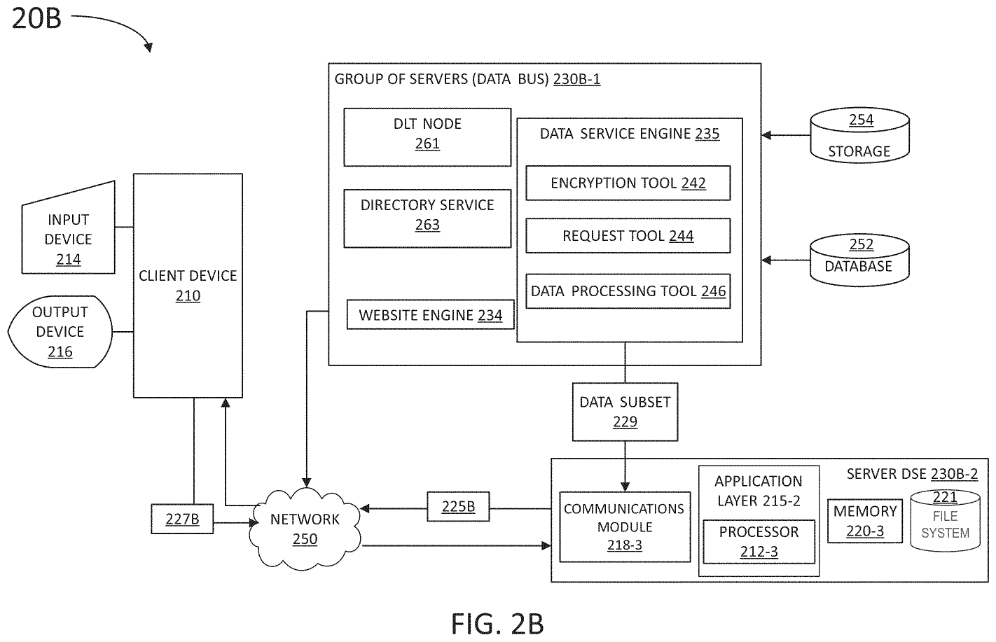

FIGS. 2A-2B illustrate block diagrams 20A-20B (hereinafter, collectively referred to as “block diagrams 20”) of devices and components used in architectures 100, according to some embodiments. A client device 210 is communicatively coupled with a server microservice 230A or a group of servers or data bus 230B-1, or to a server DSE 230B-2 (hereinafter, collectively referred to as “servers 230”), via a network 250. Client device 210 and servers 230 include communications modules 218-1, 218-2, and 218-3 (hereinafter, collectively referred to as “communications modules 218”). Communications modules 218 may include hardware and software for transmitting data through network 250. For example, communications modules 218 may include radiofrequency hardware and software (antennas, receivers, filters, and digital processing circuitry, modems, and the like). Accordingly, client device 210 may upload a message 227A or a dataset 227B onto servers 230 and receive a message 225A or download a dataset 225B from at least one of servers 230. Additionally, a database 252 or a storage 254 may be accessible by client device 210 through network 250 or servers 230 to upload dataset 227B or download dataset 225B.

Client device 210 may include accessories such as an input device 214 and an output device 216. Input device 214 may include a pointer device such as a stylus, a mouse, or a touchscreen display, or a microphone to receive voice commands from a user. Output device 216 may include a display, a touchscreen display, a speaker, a flashlight to emit visual cues, or any other haptic actuator that provides feedback to the user of client device 210.

Client device 210 and servers 230 may also include processors 212-1, 212-2, and 212-3 and memories 220-1, 220-2, and 220-3, respectively (hereinafter, collectively referred to as “processors 212” and “memories 220”). Memories 220 may store instructions and commands which, when executed by processors 212, cause client device 210 and servers 230 to perform, at least partially, one or more of the steps in methods as disclosed herein. More specifically, memories 220-1 and 220-2 may include an application 222 hosted by server microservice 230A via an application layer 215-1 and configured to securely transmit a message 225A to client device 210 and receive a message 225A from client device 210. Also, data bus 230B-1 may include a data service engine 235, a DLT node 261, a directory service 263, and a website engine 234. Data service engine 235 may include an encryption tool 242, a request tool 244, and a data processing tool 246. Website engine 234 may provide access to one or more client devices 210 to the data sharing service supported by data service engine 235. Server DSE 230B-2 may be configured to receive a data subset 229 from data bus 230B-1, via communications module 218-3. Application layer 215-2 including processor 212-3 enables the download of dataset 225B and the upload of dataset 227B to and from client device 210, into memory 220-3 and a file system 221. File system 221 may be accessed by client device 210 or any one of servers 230.

In some embodiments, storage 254 is a server, container, or pod dynamically created by servers 230 to provide client devices 210 with access to datasets 225B uploaded to network 250. In some embodiments, servers 230 build storage 254 dynamically following a request for uploading dataset 225B or downloading a dataset 227B, on network 250. In some embodiments, storage 254 stores data within the scope of a specific transaction. In some embodiments, storage 254 stores data in an encrypted format using encryption tool 242. Encryption tool 242 creates unique encryption keys for each storage 254. Accordingly, storage 254 authorizes the requestor to access the dataset and perform the requested transaction by matching a public key from the client device with a private key stored in storage 254 or in servers 230. In some embodiments, storage 254 provides database services for a limited time and limited number of attempts. In some embodiments, storage 254 is deleted automatically following a network-defined lifespan, regardless of access status. The lifespan of storage 254 can be predefined by the system. In some embodiments, the lifespan of storage 254 is calculated as a function of technical parameters and business rules including (but not limited to) size of data, number of clients who need to download data, how often the clients download data, region, and the like. In some embodiments, servers 230 only accept calls from storage 254 dedicated to uploading data 225B and invalidates the access keys after a predefined time.

Additional security is achieved by limiting client devices 210 to interact only with storage 254 instead of the entire data sharing site, e.g., servers 230 and network 250. When client device 210 downloads dataset 227B, storage 254 includes only the data that client device 210 has permission to access. When client device 210 uploads dataset 225 to network 250, it connects to storage 254 that may encrypt dataset 225 and sends it to servers 230. In some embodiments, client device 210 will never have direct access to servers 230 and all communications are handled between client devices 210 and storage 254. Storage 254 can be implemented as an out-of-box software or as a custom solution integrated into the back-end enterprise system and processes (e.g., in servers 230). Servers 230 control instances and manage access keys to storage 254. In some embodiments, storage 254 may be customized to include additional features specific to a particular organization hosting any one of servers 230.

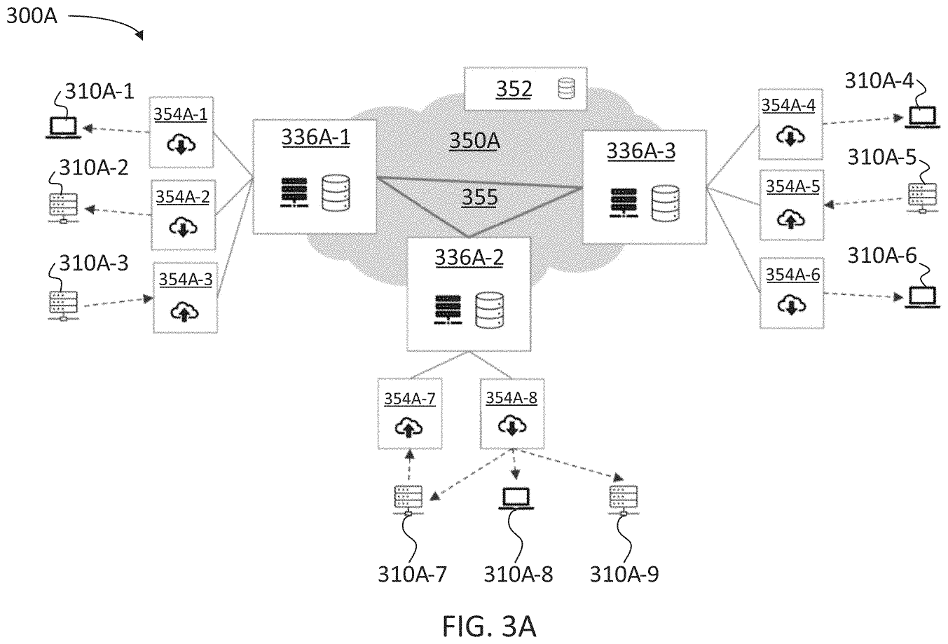

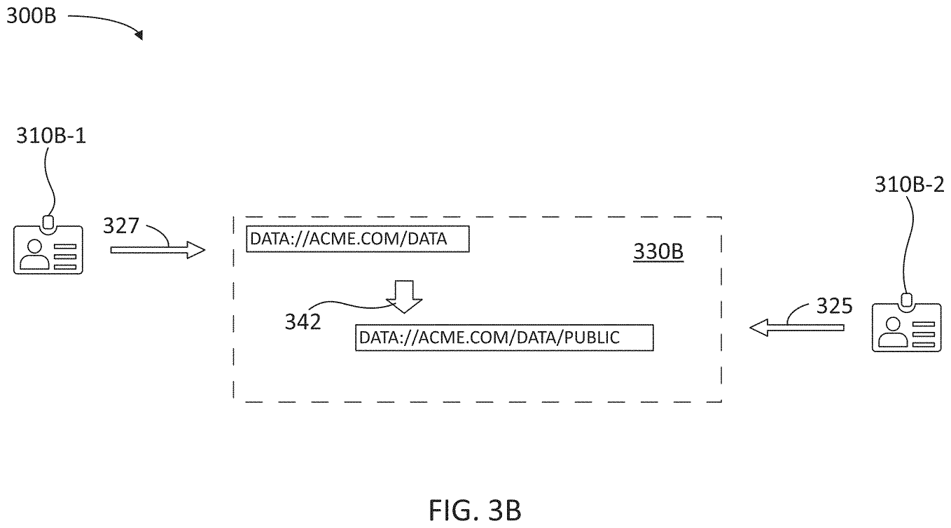

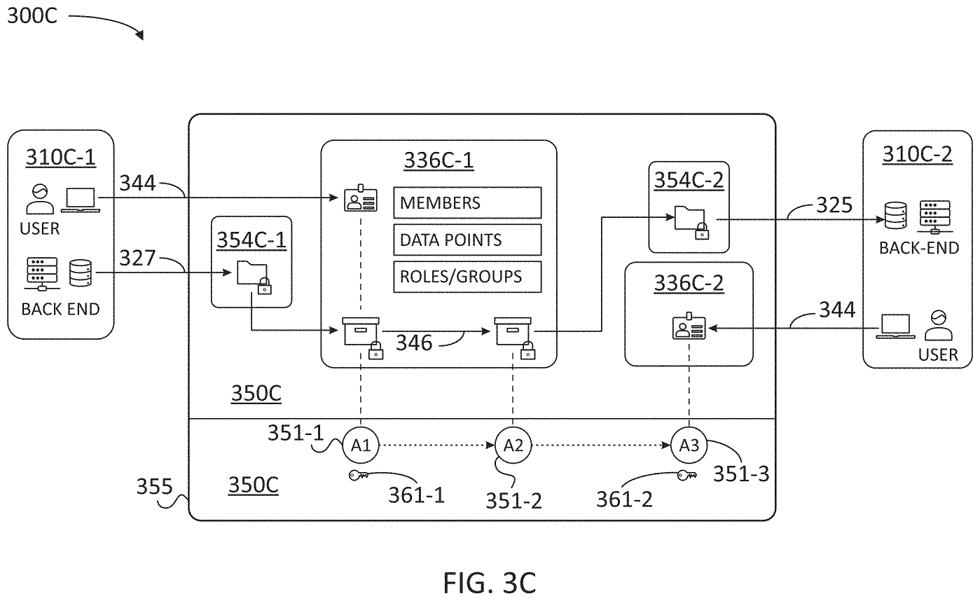

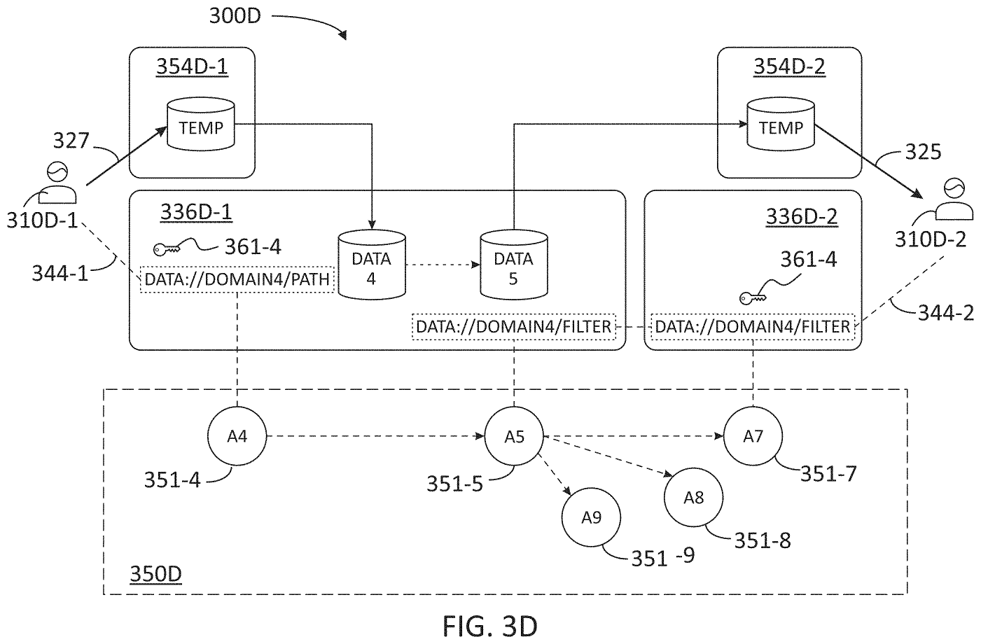

FIGS. 3A-3D illustrate examples of data sharing networks 300A, 300B, 300C, and 300D (hereinafter, collectively referred to as “data sharing networks 300”). Data sharing networks 300 include client devices 310A-1, 310A-2, 310A-3, 310A-4, 310A-5, 310A-6, 310A-7, 310A-8, and 310A-9 (hereinafter, collectively referred to as “client devices 310A”), 310B-1 and 310B-2 (hereinafter, collectively referred to as “client devices 310B”), 310C-1 and 310C-2 (hereinafter, collectively referred to as “client devices 310C”), 310D-1 and 310D-2 (hereinafter, collectively referred to as “client devices 310D”). Client devices 310A, 310B, 310C, and 310D will be collectively referred to, hereinafter, as “client devices 310.”

Data depots 336A-1, 336A-2, and 336A-3 in a data matter 350A (hereinafter, collectively referred to as “data depots 336A”) share a metadata 355. Data depots 336C-1 and 336C-2 (hereinafter, collectively referred to as “data depots 336C”), and 336D-1 and 336D-2 (hereinafter, collectively referred to as “data depots 336D”) store data uploaded by any one of client devices 310. Data depots 336A, 336C, and 336D will be collectively referred to, hereinafter, as “data depots 336.” Data depots 336 manage lists of members and datapoints. Data depots 336 store and perform transformation on member's data in the datapoints (cf. datapoints 151C) and creates derivative data points. Metadata 355 may include information on its data sources, location, method of access, content, and data format. Metadata is collected about the transactions and events from the data depot.

DSEs 354A-1, 354A-2, 354A-3, 354A-4, 354A-5, 354A-6, 354A-7, and 354A-8 (hereinafter, collectively referred to as “DSEs 354A”), 354C-1 and 354C-2 (hereinafter, collectively referred to as “DSEs 354C”), and 354D-1 and 354D-2 (hereinafter, collectively referred to as “DSEs 354D”) store data uploaded by any one of client devices 310. DSEs 354A, 354C, and 354D will be collectively referred to, hereinafter, as “DSEs 354.” DSEs 354 may have associated metadata including information on its data sources, location, method of access, content, and data format.

Data sharing networks 300 may include a decentralized network of sites that implement a Data Address Protocol by the users of client devices 310. Data sharing networks 300 include access tools to authenticate data requestors (e.g., access tool 244). For requests about data depots 336 or DSEs 354 located in a different data sharing network, data sharing networks 300 forward the request to the correct location and negotiate with each other on behalf of a data requestor. For example, an access tool in data sharing networks 300 may include community rules to authorize a data request (e.g., to determine whether a requestor has permission to access one of data depots 336 or DSEs 354). When a requestor is authorized, DSEs 354 and data depots 336 are configured to provide the requested data via translating to a proper format or performing a function for a derivative datapoint (cf. derivative datapoint 151C-2). A log of the events for future audit may be stored in database 352.

Client device 310B-1 uploads a dataset 327 onto a server 330B in data sharing network 300B. Dataset 327 may include any data that an organization or individual may share with others, which will be assigned a unique URI by server 330B. The URI may be used by data consumers to discover and access data shared by the data providers. An example of a data endpoint URI may be “data://acme.com/data,” or “data://clientOrg1/patient.” Similar to a Web URL, client device 310B-1 registers domain names with the data sharing system hosted by server 330B. Once the domain is registered, client device 310B-1 may request server 330B to generate via a mapping tool 342 any number of URIs using this domain, e.g., “data://acme.com/data/public,” or “data://clientOrg1/patient/address.” Data discovery protocols may be public and open.

The Data Address URI uses a scheme “data://,” which refers to a Data Address Protocol linking the URI with datapoint metadata. The metadata may include data owner, data description, data format, data location, and data access instructions. A particular implementation of a data address protocol may store the metadata in either a central location or a distributed database. The protocol may choose a specific format and define a way to locate the requested information by URI. For example, it can use JSON format and store datapoint metadata in “Interplanetary File system (IPFS).” In that case, the protocol will need a way to link the IPFS address of the Datapoint metadata with the Datapoint URI. Here is an example of Datapoint metadata:

{
“protocol”: “data-point”,
“version”: “1.0”,
“owner”: “BlueShield”,
“description”: “COVID Patient data”,
“format”: “application/pdf”,
“location”: “secure-net 908942-765655”
}

Datapoint metadata may include additional information to make the Data Address Protocol extendable. Additionally, datapoint metadata may have private and public parts. The public part will be available for data discovery. The private metadata may include instructions for data access control and additional information available to the owner of the datapoint (e.g., operator of client device 310B-1). To enable a decentralized architecture, the implementation of the Data Address Protocol may use DLT/Blockchain to store information about the data, e.g., addresses and the datapoint metadata. The decentralized ledger can be used for access control, audit, and provenance. The implementation of the Data Access Protocol retrieves the datapoint metadata, which will contain such instructions.

In some embodiments, the data address URI does not hold a balance. Instead, the data address URI may include metadata with unique information associated with data outside of a datapoint ledger. Unlike Non-Fungible tokens (NFTs), the metadata maintains the same data owner. Accordingly, it reflects permissions granted to other addresses to access corresponding data (e.g., meta facts). The address owner (e.g., server 330) can post a transaction that grants or revokes such permissions. In addition to the permissions state, data sharing network 300B also keeps metadata that may indicate that the data address performs data transformations.

The metadata contains a digital digest, preview, or summary of the original data. Server 330B can optionally sign the digest. This information can be used to confirm the integrity of the data. That means that a ledger in data sharing network 300B has an accurate state of linked datasets 325 and 327 at a given moment. That information can be used as an ultimate audit of different types of data transactions.

Data sharing network 300C is a blockchain network to secure access to DSEs 354C-1 and 354C-2 (hereinafter, collectively referred to as “DSEs 354C,” including derivative data endpoints) by client devices 310C-1 and 310C-2 (hereinafter, collectively referred to as “client devices 310C”). The blockchain network may include an IPFS 355 having a data matter 350C with datapoints 351-1, 351-2, and 351-3 (hereinafter, collectively referred to as “datapoints 351”), accessible through encryption keys 361-1 and 361-2.

Client device 310C-1 may upload a dataset 327 onto DSE 354C-1, and client device 310C-2 may download dataset 325 from DSE 354C-2. Accordingly, data sharing network 300C may use smart contracts to enable a secure and immutable ledger with access control and transactions. Client devices 310C may include a back end with databases and networking components, and a front end with a display for user interface, a desktop, and the like. In some embodiments, data sharing network 300C includes a decentralized network of nodes or data depots 336C-1 and 336C-2 (hereinafter, collectively referred to as “data depots 336C”) that maintain a distributed ledger and use any suitable consensus mechanism. Datapoint 351-1 may be a source datapoint for a derived datapoint 351-2, which then transfers the processed data to datapoint 351-3, where it is locked under encryption key 361-2. Data sharing network 300C can also be implemented on top of an existing blockchain platform.

Access to data depots 336C is obtained through private keys 346 in blockchain network 350C via access attributes 344 provided by an encryption tool and a request tool, respectively (cf. encryption tool 242 and request tool 244). Data depots 336C may include members that can access it, and datapoints storing data loaded and accessible by members. Data depots 336C may also assign roles and groups to its members and provide a layered access with differentiated privileges to datapoints, for different members. A member metadata may include information about location and updates for each member.

Data sharing network 300D includes a client device 310D-1 uploading a dataset 327 onto DSE 354D-1, which loads the dataset onto data depot 336D-1, which applies an encryption key 361-4 and assigns a URI address 344-1 to dataset 327. Dataset 327 may be transformed (e.g., filtered) and transferred to data depot 336D-2, which applies encryption key 361-4, in a new URI address 344-2 (hereinafter, URI address 344-1 and 344-2 will be collectively referred to as “URI addresses 344,” and encryption keys 361-1, 361-2, and 361-4 will be referred to as “encryption keys 361”). A dataset 325 is downloaded by client device 310D-1. At each of URI addresses 344, datapoints 351-4, 351-5, 351-7, 351-8, or 351-9 (hereinafter, collectively referred to as “datapoints 351”) may access data depots 336D using a private key matching encryption keys 361.

A flow of processes consistent with the present disclosure can take place in data sharing network 300D.

Process 1: Wherein an organization A4 registers with data depot 336D-1 and creates datapoint 351-4 with the following URI: data://domain4/path. Data depot 336D-1 creates an address for datapoint 351-4 (e.g., data://domain4/path) in data matter 350D and stores encryption key 361-4 in a database within datapoint 351-4.

Process 2: Wherein organization A4 sends a request to data depot 336D-1 to upload data to datapoint 351-4. Data depot 336D-1 creates DSE 354D-1 and shares connection settings with the Org 4.

Process 3: Wherein Org 4 connects to DSE 354D-1 and uploads data using a data transfer protocol. DSE 354D-1 registers the upload event on the data matter and sends the data, to data depot 336D-1, which encrypts and stores them in datapoint 351-4. Then DSE 354D-1 deletes the data stored therein.

Process 4: Wherein an organization 7 registers with data depot 336D-2.

Process 5: Wherein organization 4 sets up a derivative datapoint 351-5 that contains a subset of data stored in data://domain4/path (datapoint 351-4). The URI for the new datapoint is data://domain4/filter. Organization 4 provides a query for a transformation. Data depot 336D-1 creates address A5 in data matter 350D and stores private key 361-4 in the database within datapoint 351-5. Data depot 336D-1 registers the data transformation as a function in data matter 350D.

Process 6: Wherein organization 4 creates a group that has access to datapoint 351-5 (at URI address data://domain4/filter). The group includes members A9 with datapoint 351-9, A8 with datapoint 351-8, and a member organization 7 with datapoint 351-7. Data depot 336D-2 creates an address for datapoint 351-7 in data matter 350D and stores private key 361-4 in a database within datapoint 351-7. Then it registers data sharing between A5 and A7.

Process 7: Wherein organization 7 sends a request to data depot 336D-2 to download data from derivative datapoint 351-5 (URI data://domain4/filter). Data depot 336D-2 validates the permission using both directory and data matter 350D. Data depot 336D-2 sends a request to data depot 336D-1 to create DSE 354D-2. Data depot 336D-1 creates DSE 354D-2, runs the query, and uploads the encrypted query result therein. Data depot 336D-2 sends connection settings for DSE 354D-2 to organization 7.

Process 8: Wherein organization 7 connects to DSE 354D-2 and downloads data using a secure data transfer protocol. DSE 354D-2 registers the download event on data matter 350D.

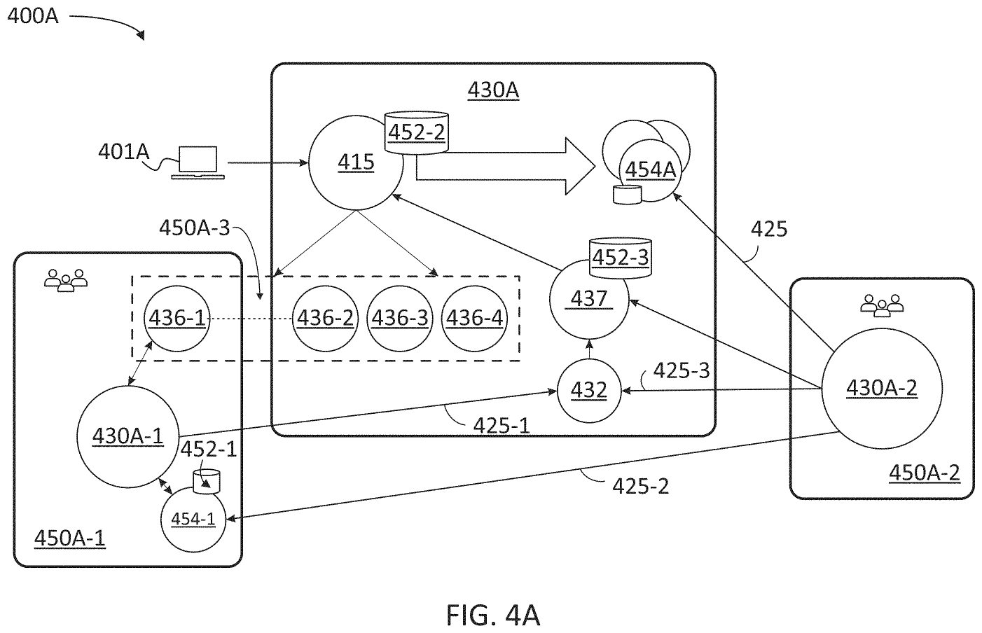

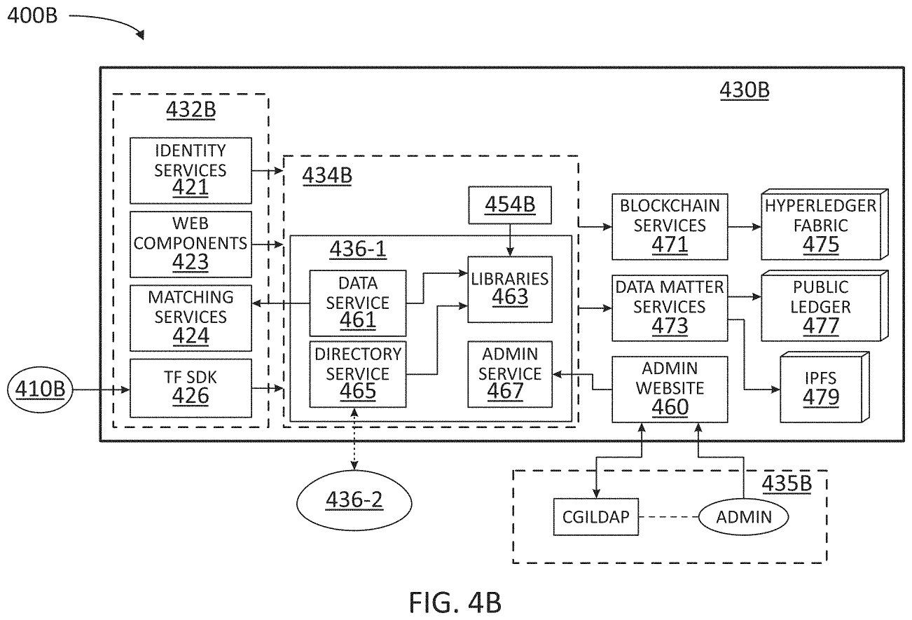

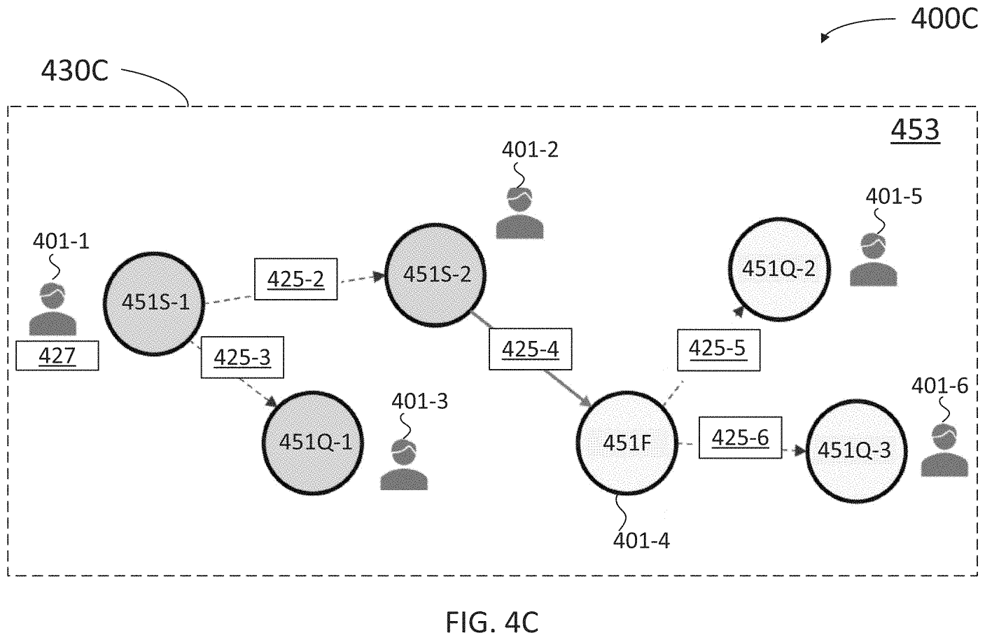

FIGS. 4A-4C illustrate more examples of secure networks 400A, 400B, and 400C (hereinafter, collectively referred to as “secure networks 400”), according to some embodiments. Users or data providers 401A, 401-1, 401-2, 401-3, 401-4, 401-5, and 401-6 (hereinafter, collectively referred to as “data providers 401”) upload and download datasets 427, 425-1, 425-2, 425-3, 425-4, 425-5, and 425-6 (hereinafter, collectively referred to as “datasets 425”) using client device 410B, and the like. Secure networks 400 may also create a data access control list (ACL) including a role (e.g., owner, doctor, data scientist, institution, and the like), a path, a grant (Allow/Deny), and an action taken (Read/Write, or both) for specific data transactions in the system. In some embodiments, the system may use the ACL and a datapoint hierarchy to determine an effective access to a particular resource.

Data sharing network 400A includes an administrator 401A that has access to a server 430A via an application programming interface (API) 415. In some embodiments, data sharing network 400A implements a Decentralized Ledger Technology (DLT) for a blockchain network, to secure data operations. Members can read a data provenance log that contains information that can be used to verify any transaction related to sharing data. Data sharing network 400A includes a ledger 450A-3, storing transactions for the data-sharing ecosystem. Ledger 450A-3 can be accessed by different servers through the blockchain network. API 415 provides core services, linking to one or more data sharing service (DSS) nodes 436-1, 436-2, 436-3, and 436-4 (hereinafter, collectively referred to as “DSS nodes 436”), which may be part of ledger 450A-3. In addition, API 415 may have connectivity with DSE 454A and other databases 452-1, 452-2, and 452-3 (hereinafter, collectively referred to as “databases 452”) in a database network 450A-1 that handles datasets 425-1, 425-2, and 425-3 (hereinafter, collectively referred to as “datasets 425”) with one or more client back-ends 430A-1 and 430A-2 in a client network 450A-2 (hereinafter, collectively referred to as “client back-ends 430A”). Client network 450A-2 may include private individuals, organizations, and companies that belong in data sharing network 400A, which may not necessarily be coupled with one another, although two or more client back-ends 430A may communicate with each other outside of the main server in the data sharing network. Client back-ends 430A may access a web portal 432 hosted by server 430A. In some embodiments, web portal 432 is handled by its own API (e.g., HIP API 437) and a database 452-3.

In some embodiments, the system may create a data endpoint uniform resource identifier (URI) to each, or at least one of DSS nodes 436, to enable discovery and sharing of its contents.

In some embodiments, DSS nodes 436 may include derivative data endpoints 454. In some embodiments, data sharing network 400A implements functions and queries data endpoint 454-1 that derives data from DSS nodes 436 (e.g., via the respective URIs). Accordingly, a global network of derivative data may emerge, according to some embodiments.

Data sharing network 400B includes client device 410B coupled with server 430B. Server 430B may provide web services 432B and data services 434B. Data sharing network 400B may include a Kubernetes cluster running data depots 436-1 and 436-2 (hereinafter, collectively referred to as “data depots 436”), DSE 454B, blockchain services 471, data matter 473, Hyperledger fabric 475, and other cloud services such as public ledger 477, IPFS node 479, cloud storage, NoSQL (non-tabular) database, and the like. In some embodiments, DSE 454B is a Kubernetes node (server) that is dynamically created by data depot 436-1 to allow clients to upload or download data. Web services 432B may include identity services 421, web components 423, matching services 424, and other software development kits (SDK) 426. Data services 434B may include DSE service 454B, and data depot 436-1. Data depot 436-1 may include data services 461, libraries 463, directory service 465, and administrative services 467. In some embodiments, an external data depot 436-2 may be coupled with server 430B for extra storage. An administrator 435B manages and controls server 430B via an administration website 460.

Data sharing network 400C may be a blockchain network that includes a server 430C having a ledger 453. Ledger 453 includes several types of datapoints 451, each associated with a URI address. Each of address owners 401-1, 401-2, 401-3, 401-4, 401-5, and 401-6 (hereinafter, collectively referred to as “address owners 401”) has access to a corresponding DSE, which may include, without limitation: a stream datapoint 451S-1 (e.g., a datapoint that includes a data source) that gives rise to a query datapoint 451Q-1 (e.g., a datapoint accessed by users to query for data, e.g., from a stream datapoint). A stream datapoint 451S-2 gives rise to a functional datapoint 451F followed by query datapoints 451Q-2 and 451Q-3. Datapoints 451Q-1, 451Q-2, and 451Q-3 will be collectively referred to, hereinafter, as “query datapoints 451Q.” Stream datapoints 451S-1 and 451S-2 (hereinafter, collectively referred to as “stream datapoints 451S”) allow a data provider 401 to replace or append datasets 425 from internal resources. Functional datapoint 451F stores data created as a result of executing a function (e.g., a filter, a query, and the like) on any of datasets 425. The function reads data from another stream datapoint 451S. Accordingly, the output of the address at datapoint 451F is different from the input stream datapoint 451S. The function uses input data to compute the new data. In some embodiments, data providers 401 do not write to functional datapoint 451F directly. Query datapoints 451Q are similar to functional datapoint 451F except that 451F does not store data. Datapoints 451S, 451Q, and 451F will be collectively referred to, hereinafter, as “datapoints 451.” Address owners 401 form a data community network. Server 430C is illustrated as a graph of datapoints 451 and their relationships preserve private information from unauthorized parties, wherein access permissions reflect resource sharing status.

Datapoints 451 may include a function at the time when the data consumer reads the data from the datapoint. Functional and query datapoints 451F and 451Q may use any datapoint 451S as a source, thus creating a chain of dependency. Address owners 401 can use an API in server 430C (cf. API 215) to record an intent to update datasets 425. Similarly, server 430C controls permission to write data to any of datapoints 451. Server 430C also updates the metadata associated with each of datapoints 451 and their addresses, if desirable. Server 430C may also give another address permission to access data associated with this address and implements data sharing. Server 430C may also declare a transformation function, updates the transformation metadata, and reports that the data transformation was successful, and a new data was created. Server 430C also keeps a log to record data access attempts and confirmation that the data has been received by the appropriate party or address owner 401.

Server 430C may include metadata with unique information associated with data outside of ledger 453. Unlike non-fungible tokens, the metadata in server 430C maintains address owners 401. For example, the metadata includes metafacts, reflecting permissions granted to other addresses to access corresponding data. Address owners 401 can post a transaction that grants or revokes such permissions. In addition to the permissions state, server 430C also keeps metadata that may indicate that a certain address owner 401 performs data transformations.

An address owner 401 can use an API coupled with server 430C to perform several operations: Record an intent to update the data (e.g., asking permission to write data to server 430C); update the metadata: e.g., updating the actual data in the store associated with address owner 401; give another address permission to access data associated with address owner 401 (e.g., implement data sharing); and declare a transformation function: e.g., the output of address owner 401 will be different from the input. The function can use input data to compute new data; update the transformation metadata, e.g., data indicative that the data transformation was performed and new data was created; and record an intent to access data, e.g., record the confirmation that the data has been received. In some embodiments, the metadata contains a digital digest of the original data. Address owner 401 can optionally sign the digest. Information in the digest can be used to confirm the integrity of the data. Accordingly, ledger 453 has an accurate state of all linked data sets at every given moment. That information can be used as an ultimate audit of all kinds of data transactions.

Each member of data sharing chain 440C may use the data differently. Address owners 401 may need to enrich data records with their attributes (e.g., properties of metadata associated with the address). Some of these attributes have value only for their creators. However, when a new fact reflects a relationship between entities, such information adds another dimension to the data. Accordingly, server 430C may collect relationships between address owners 401 such that the graph for data sharing chain 440 can be searched and analyzed separately from datasets 425. Server 430C records relationships between entities (records, objects, etc.). The graph nodes include a unique identifier and some common attributes that can be used for searching. Private data, including personally identifiable information, are not included for privacy reasons. Address owners 401 can use the unique ID or other attributes of the node to look up and identify those graph entities known to the participant.

Data sharing chain 440C implies address owners 401 provide infrastructure and software to each other to access datasets 425. The party who shares data provides value to everyone who consumes this data and provides shareable tokens as a virtual currency that represents the value of sharing datasets 425. Network participants can use shareable tokens to leverage cost savings, monetize their data, and analyze the dynamic of data sharing processes. A community where a few participants bear a large portion of the cost associated with data hosting can use shareable tokens to distribute the cost among participants. Address owners 401 may define the monetary value of each shareable token, the method by which they get allocated, and how they get cashed in.

In addition, owners 401 may record every event of data consumption and associates with it a certain number of shareable tokens transferred from the consumer to the provider. Such a scheme generates virtual currency and creates automated settlement scores. In some embodiments, the token exchange may be automatically linked to consumption of datasets 425 (e.g., a shareable token). Address owners 401 can use this currency to leverage cost savings, monetize datasets 425, and analyze the dynamic of data sharing processes. In configurations where a few address owners 401 bear a large portion of the cost associated with data hosting, shareable tokens can be used to distribute the cost among all or most of address owners 401.

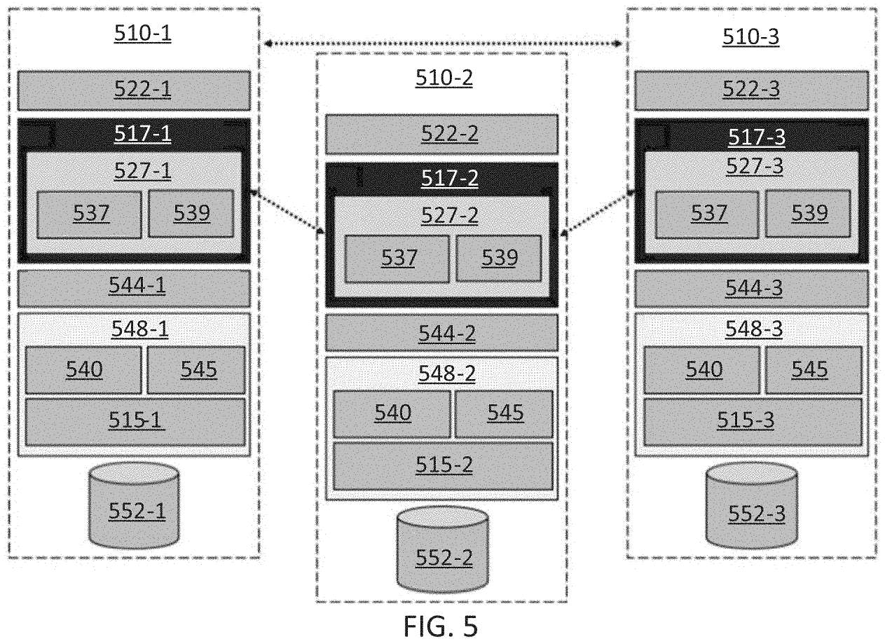

FIG. 5 illustrates back-end systems for client devices 510-1, 510-2, and 510-3 (hereinafter, collectively referred to as “client devices 510”) in a data sharing network (e.g., data sharing networks 400), according to some embodiments. Client devices 510 may include individuals, or servers hosting a variety of different network services, and may be considered as “peers” in the data sharing network. Each of the peers may have different authorization levels and access privileges to different types of data in the data sharing network. Each of the peer devices may include a “legacy” database 552-1, 552-2, and 552-3 (e.g., their own database used within their service network, hereinafter, collectively referred to as “databases 552”), an application layer 522-1, 522-2, and 522-3 (hereinafter, collectively referred to as “application layers 522”), and a messaging layer 548-1, 548-2, and 548-3 (hereinafter, collectively referred to as “messaging layers 548”). Messaging layers 548 include translators 540, adaptors 545, and API gateways 515-1, 515-2, and 515-3 (hereinafter, collectively referred to as “API gateways 515”). Other features in the peer devices may include distributed ledgers 517-1, 517-2, and 517-3 (hereinafter, collectively referred to as “distributed ledgers 517”) to publish at least a data portion in a blockchain network, and access control. In some embodiments, the access control and distributed ledgers 517 are handled by smart contracts 527-1, 527-2, and 527-3 (hereinafter, collectively referred to as “smart contracts 527”), linking one or more of client devices 510 with one another and with a central server in the data sharing network. Smart contracts 527 may include a role metadata 537 that lists the access privileges 544-1, 544-2, and 544-3 (hereinafter, collectively referred to as “access privileges”) of each of client devices 510 within the blockchain network, and a notary 539 that distributes authenticated signature files to validate each transaction in the blockchain network.

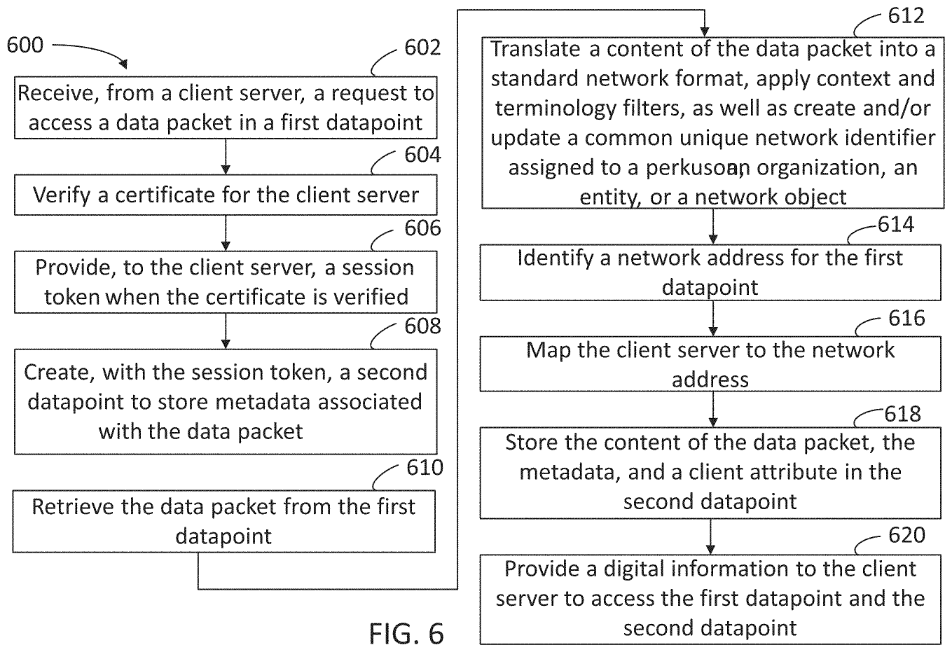

FIG. 6 is a flow chart in a method 600 to access a data packet in a data sharing network, according to some embodiments. Method 600 may be performed, at least partially, by a server or computer as disclosed herein (e.g., servers 130, 230, 330, 430, client devices 110, 210, 310, 410, and 510), said server or computer including a memory storing instructions and one or more processors configured to execute the instructions to cause the server or computer to perform at least partially, one step in method 600 (cf. processors 212 and memories 220). The instructions may be part of a data sharing engine, or a web portal engine as disclosed herein (cf. data service engine 235 and website engine 234). The data service engine may include an encryption tool, a request tool, and a data processing tool (cf. encryption tool 242, request tool 244, and data processing tool 246). The web portal engine may include a messaging tool. In some embodiments, a method consistent with method 600 may include one or more of the steps disclosed herein but performed in a different order, simultaneously, quasi-simultaneously, or overlapping in time.

Step 602 includes receiving, from a client server, a request to access a data packet in a first datapoint. In some embodiments, the client server is a legacy client service provider in a network, and step 602 includes a request to publish the data packet in the datapoint. In some embodiments, the client server is an application program interface accessed by a third-party user, and step 602 includes receiving a request for a bulk data download from the third-party user. In some embodiments, the client server is an application program interface in a service provider network accessed by an authorized user of the service provider network, and step 602 includes receiving a data request from the service provider network.

Step 604 includes verifying a certificate for the client server. A certificate represents any form of authentication.

Step 606 includes providing, to the client server, a session token when the certificate is verified.

Step 608 includes creating, with the session token, a second datapoint to store a metadata associated with the data packet. In some embodiments, step 608 includes updating a time stamp in the container associated with the client server.

Step 610 includes retrieving the data packet from the first datapoint. In some embodiments, step 610 includes pulling the data packet from the staging datapoint.

Step 612 includes translating a content of the data packet into a standard network format, applying context and terminology filters, as well as creating and/or updating of a common unique network identifier assigned to persons, organizations, entities, or network objects. In some embodiments, step 612 includes creating a review case, when a common ID cannot be determined.

Step 614 includes identifying a network address for the first datapoint. In some embodiments, when more than one datapoint associated with the client server is identified, step 614 includes creating a review case associated with an encrypted signature file when a common ID cannot be determined for a given person/entity, updating a publication statistic for the client server, and verifying the publication statistics with the encrypted signature file. In some embodiments, step 614 includes creating a new datapoint associated with the client server when no container is identified. In some embodiments, when more than one datapoint associated with the client server is identified, step 614 includes retrieving the metadata from the second datapoint from at least one of the datapoints associated with the client server and deactivating the client attribute when a time stamp in the metadata is not updated.

Step 616 includes mapping the client server to the network address.

Step 618 includes storing the content of the data packet, the metadata from the staging datapoint, and a client attribute in the second datapoint.

Step 620 includes providing a digital information to the client server to access the first datapoint and the second datapoint. In some embodiments, step 620 includes publishing the data packet in a blockchain network accessible to users of the blockchain network via a public key.

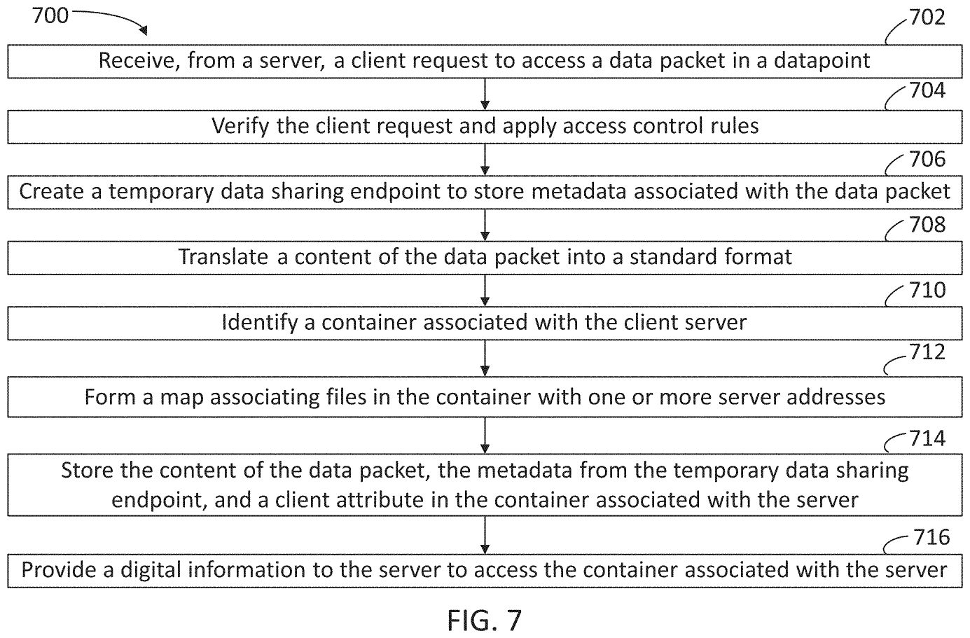

FIG. 7 is a flow chart in a method 700 to access a data packet in a data sharing network, according to some embodiments. Method 700 may be performed, at least partially, by a server or computer as disclosed herein (e.g., servers 130, 230, 330, 430, client devices 110, 210, 310, 410, and 510), said server or computer including a memory storing instructions and one or more processors configured to execute the instructions to cause the server or computer to perform at least partially, one step in method 700 (cf. processors 212 and memories 220). The instructions may be part of a data sharing engine, or a web portal engine as disclosed herein (cf. data service engine 235 and website engine 234). The data service engine may include an encryption tool, a request tool, and a data processing tool (cf. encryption tool 242, request tool 244, and data processing tool 246). The web portal engine may include a messaging tool. In some embodiments, a method consistent with method 700 may include one or more of the steps disclosed herein but performed in a different order, simultaneously, quasi-simultaneously, or overlapping in time.

Step 702 includes receiving, from a server, a client request to access a data packet in a datapoint.

Step 704 includes verifying the client request and applying access-control rules. In some embodiments, the verification may be implemented with a smart contract. In some embodiments, step 704 includes verifying a certificate for the server. In some embodiments, step 704 includes providing, to the server, a session token when a certificate in the smart contract is verified. In some embodiments, step 704 includes identifying the client attribute in the smart contract, and validating the client request based on the client attribute.

Step 706 includes creating a temporary data sharing endpoint to store a metadata associated with the data packet, based on the smart contract.

Step 708 includes translating a content of the data packet into a standard format. In some embodiments, the data packet is already in standard format, and it can be translated back into a client-specified format. In some embodiments, step 708 includes determining data that can be shared with a role/user. For example, when a client user cannot see certain fields/data, the data may be masked (e.g., SSN, street address cannot be shared). In some embodiments, this processing is done before step 714 (storing the data).

Step 710 includes identifying a container associated with the server.

Step 712 includes forming a map associating files in the container with one or more server addresses.

Step 714 includes storing the content of the data packet, the metadata from the temporary data sharing endpoint, and a client attribute in the container associated with the server. In some embodiments, step 714 includes updating the smart contract with a signature file executed at the server using the encrypted key, and publishing the data packet in a blockchain network.

Step 716 includes providing a digital information to the server to access the container associated with the server.

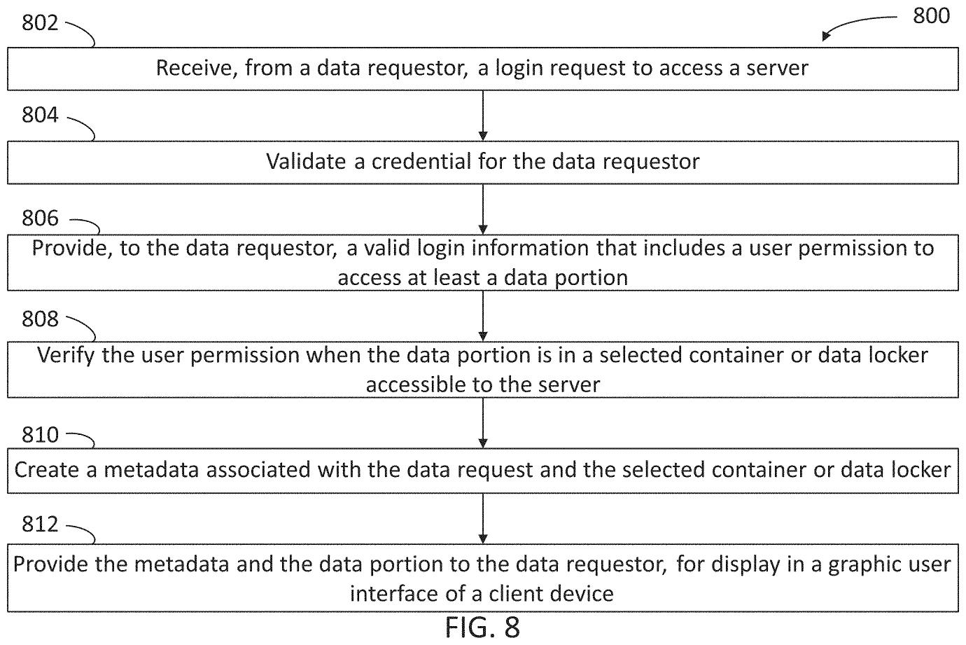

FIG. 8 is a flow chart in a method 800 to login to a data sharing network by an individual, and to retrieve personal information, according to some embodiments. Method 800 may be performed, at least partially, by a server or computer as disclosed herein (e.g., servers 130, 230, 330, 430, client devices 110, 210, 310, 410, and 510), said server or computer including a memory storing instructions and one or more processors configured to execute the instructions to cause the server or computer to perform at least partially, one step in method 800 (cf. processors 212 and memories 220). The instructions may be part of a data sharing engine, or a web portal engine as disclosed herein (cf. data service engine 235 and website engine 234). The data service engine may include an encryption tool, a request tool, and a data processing tool (cf. encryption tool 242, request tool 244, and data processing tool 246). The web portal engine may include a messaging tool. In some embodiments, a method consistent with method 800 may include one or more of the steps disclosed herein but performed in a different order, simultaneously, quasi-simultaneously, or overlapping in time.

Step 802 includes receiving, from a data requestor, a login request to access a server.

Step 804 includes validating a credential of the data requestor.

Step 806 includes providing, to the data requestor, a valid login information that includes a user permission to access at least a data portion.

Step 808 includes verifying the user permission when the data portion is in a selected container or datapoint accessible to the server. In some embodiments, step 808 further includes returning an error message to the data requestor and creating a signature file, when the user permission is not verified. In some embodiments, step 808 includes creating a data sharing endpoint for a database containing the data portion, based on a role of a peer server associated with the database.

Step 810 includes creating a metadata associated with the data request and the selected container or datapoint.

Step 812 includes providing the metadata and the data portion to the data requestor, for display in a graphic user interface of a client device. In some embodiments, step 812 further includes providing a signature file to a peer server when the data portion is part of a peer database.

In some embodiments, the data portion is in a peer server, and accessing the data portion includes creating a data sharing endpoint based on a role of the peer server and storing the data portion in the data sharing endpoint.

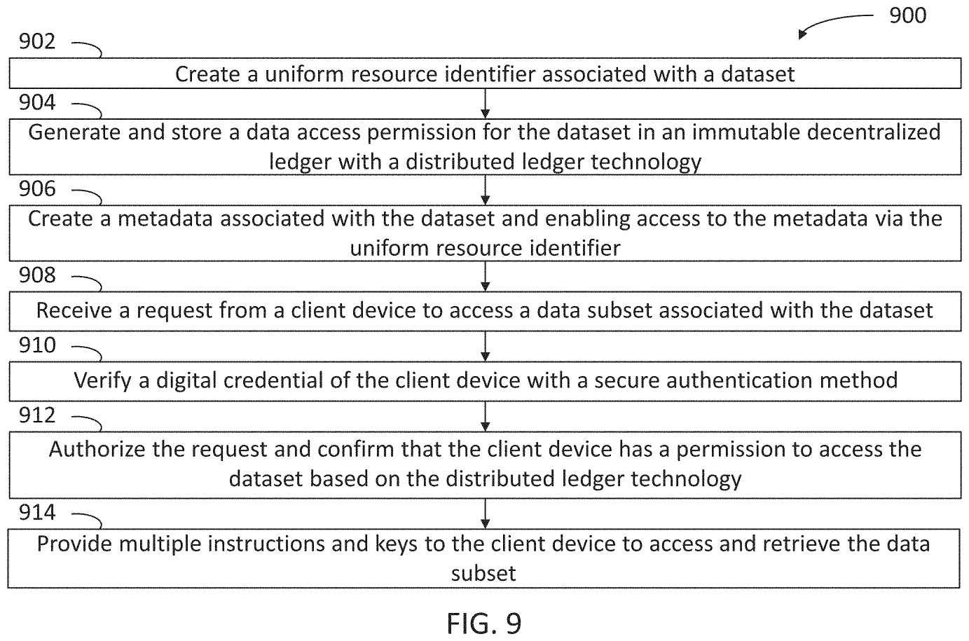

FIG. 9 is a flow chart illustrating a method 900 for data sharing using a distributed network technology, according to some embodiments. Method 900 may be performed, at least partially, by a server or computer as disclosed herein (e.g., servers 130, 230, 330, 430, client devices 110, 210, 310, 410, and 510), said server or computer including a memory storing instructions and one or more processors configured to execute the instructions to cause the server or computer to perform at least partially, one step in method 900 (cf. processors 212 and memories 220). The instructions may be part of a data sharing engine, or a web portal engine as disclosed herein (cf. data service engine 235 and website engine 234). The data service engine may include an encryption tool, a request tool, and a data processing tool (cf. encryption tool 242, request tool 244, and data processing tool 246). The web portal engine may include a messaging tool. In some embodiments, a method consistent with method 800 may include one or more of the steps disclosed herein but performed in a different order, simultaneously, quasi-simultaneously, or overlapping in time.

Step 902 includes creating a uniform resource identifier associated with a dataset. In some embodiments, step 902 includes defining a data point that describes a dataset by combining its purpose, source, and format while disregarding its physical location, storage, access protocol, and content. In some embodiments, step 902 includes creating, for a data point, a unique virtual address and generating a uniform resource identifier using a scheme to enable a discovery and access the dataset by using a data access protocol. In some embodiments, step 902 includes creating a centralized catalog for multiple data points. In some embodiments, step 902 includes creating a de-centralized catalog for multiple data points. In some embodiments, step 902 includes allowing a search query from a client device to discover a uniform resource identifier for a data point, and accessing, with a data address protocol, a metadata associated with the data point.

Step 904 includes generating and storing a data access permission for the dataset in an immutable decentralized ledger with a distributed ledger technology.

Step 906 includes creating a metadata describing the dataset and enabling access to the metadata via the uniform resource identifier. In some embodiments, step 906 includes specifying instructions on how to access the dataset using a data access protocol, wherein the instructions include a network address, and a data structure to retrieve the dataset. In some embodiments, step 906 includes generating a virtual dataset that is at least partially computed as a result of processing information retrieved from one or several parent data sets. In some embodiments, step 906 includes documenting, automating, and implementing an information processing stage, and allowing, with the information processing stage, a computation to be available for retrieving or to be used as a data source for a derivative data point.

Step 908 includes receiving a request from a client device to access a data subset associated with the dataset.

Step 910 includes verifying a digital credential of the client device using a secure authentication method. In some embodiments, step 910 includes updating a state of a data sharing network with the distributed ledger technology and a smart contract, and registering access permission controlled by RBAC, ABAC, or any other policy-based access-control method. In some embodiments, step 910 includes maintaining an immutable log of transactions related to changing access permission and accessing data in a data point with the distributed ledger technology to maintain.

Step 912 includes authorizing the request and confirming that the client device has a permission to access the dataset based on the distributed ledger technology. In some embodiments, step 912 includes using the distributed ledger technology and an immutable log of transactions for: validating an end-to-end account of a provenance, an update, and a transformation of the dataset, and validating an end-to-end account of a provenance, an update, and a transformation of the dataset through a graph of a derivative data point.

Step 914 includes providing multiple instructions and keys to the client device to access and retrieve the data subset. In some embodiments, step 914 includes forming a community network among multiple participants that share a data point and forming an anonymized graph of multiple datapoints including a derivative relationship and a data access state. In some embodiments, step 914 includes using data from an immutable log for: calculating a relative value of a contribution of a network participant to the data sharing and transformation process, and measuring, with a token, how much more the network participant contributes to a third-party network operation.

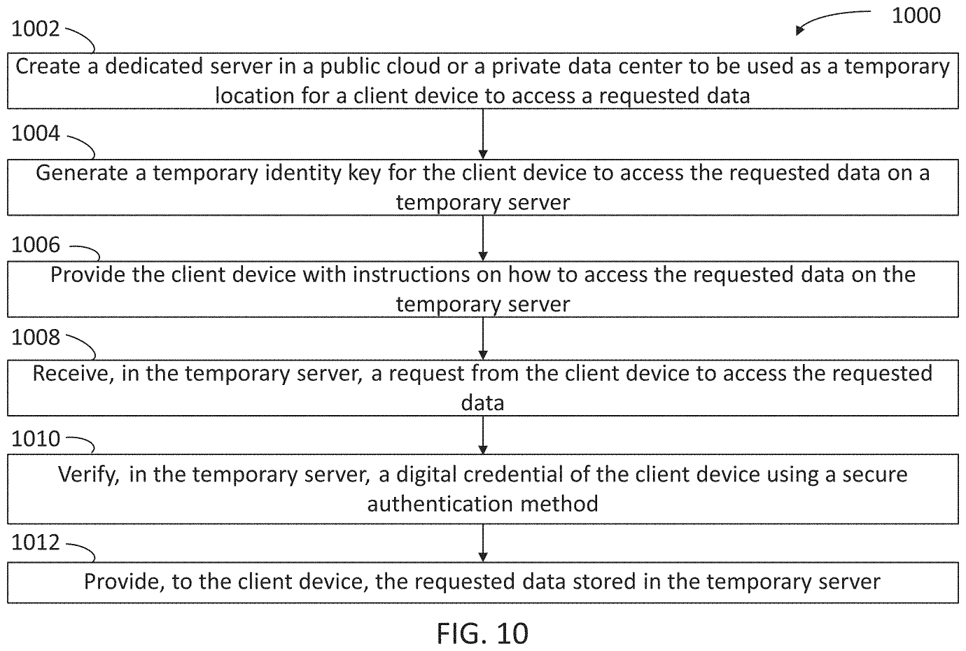

FIG. 10 is a flow chart illustrating a method 1000 for providing a requested data to a client device using a digital credential, according to some embodiments. Method 1000 may be performed, at least partially, by a server or computer as disclosed herein (e.g., servers 130, 230, 330, 430, client devices 110, 210, 310, 410, and 510), said server or computer including a memory storing instructions and one or more processors configured to execute the instructions to cause the server or computer to perform at least partially, one step in method 1000 (cf. processors 212 and memories 220). The instructions may be part of a data sharing engine, or a web portal engine as disclosed herein (cf. data service engine 235 and website engine 234). The data service engine may include an encryption tool, a request tool, and a data processing tool (cf. encryption tool 242, request tool 244, and data processing tool 246). The web portal engine may include a messaging tool. In some embodiments, a method consistent with method 800 may include one or more of the steps disclosed herein but performed in a different order, simultaneously, quasi-simultaneously, or overlapping in time.

Step 1002 includes creating a dedicated server in a public cloud or a private data center to be used as a temporary location for a client device to access a requested data. In some embodiments, step 1002 includes encrypting a data subset with the temporary identity key and storing the requested data on the temporary server.

Step 1004 includes generating a temporary identity key for the client device to access the requested data on a temporary server. In some embodiments, step 1004 includes destroying the temporary server either immediately after the client device accesses the requested data or after a predefined time.

Step 1006 includes providing the client device with instructions on how to access the requested data on the temporary server. In some embodiments, step 1006 includes reusing a same temporary server to provide multiple clients with access to a same data assuming every client has verified permission to access this data subset.

Step 1008 includes receiving, in the temporary server, a request from the client device to access the requested data.

Step 1010 includes verifying, in the temporary server, a digital credential of the client device using a secure authentication method.

Step 1012 providing, to the client device, the requested data stored on the temporary server.

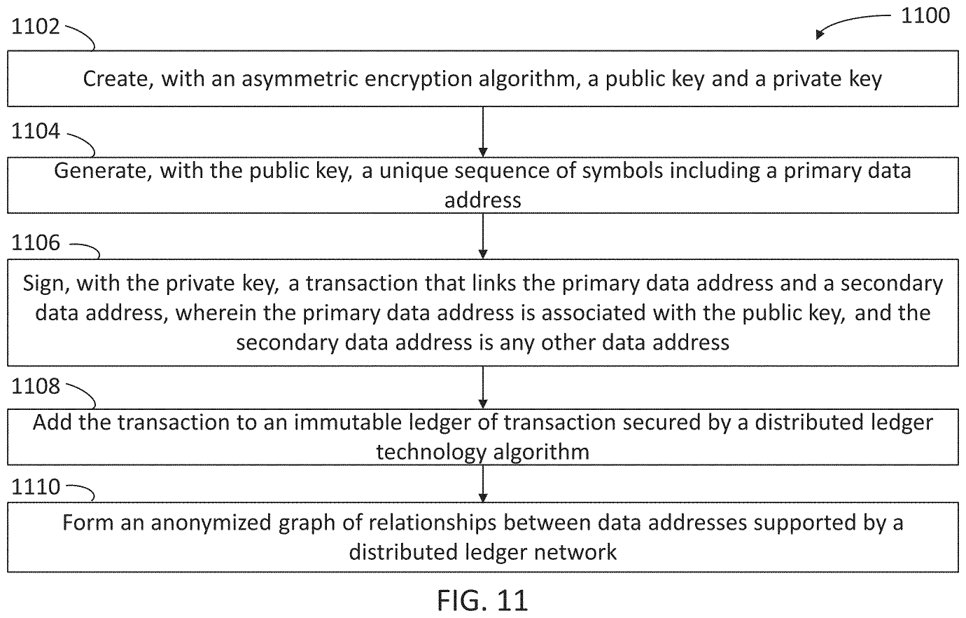

FIG. 11 is a flow chart illustrating a method 1100 of forming an anonymized graph of relationships in a distributed ledger network, according to some embodiments. Method 1100 may be performed, at least partially, by a server or computer as disclosed herein (e.g., servers 130, 230, 330, 430, client devices 110, 210, 310, 410, and 510), said server or computer including a memory storing instructions and one or more processors configured to execute the instructions to cause the server or computer to perform at least partially, one step in method 1100 (cf. processors 212 and memories 220). The instructions may be part of a data sharing engine, or a web portal engine as disclosed herein (cf. data service engine 235 and website engine 234). The data service engine may include an encryption tool, a request tool, and a data processing tool (cf. encryption tool 242, request tool 244, and data processing tool 246). The web portal engine may include a messaging tool. In some embodiments, a method consistent with method 800 may include one or more of the steps disclosed herein but performed in a different order, simultaneously, quasi-simultaneously, or overlapping in time.

Step 1102 includes creating, with an asymmetric encryption algorithm, a public key and a private key. In some embodiments, step 1102 includes creating an association between a requested dataset and the primary data address.

Step 1104 includes generating, with the public key, a unique sequence of symbols including a primary data address. In some embodiments, step 1104 includes allowing a share of a dataset associated with the primary data address with the secondary data address.

Step 1106 includes signing, with the private key, a transaction that links the primary data address and a secondary data address, wherein the primary data address is associated with the public key, and the secondary data address is any other data address. In some embodiments, step 1106 includes generating a transaction that describes a dataset that has been copied from a data source associated with the primary data address to a destination associated with the primary data address, and including in the transaction a message digest of the data and an associated metadata.

Step 1108 includes adding the transaction to an immutable ledger of transaction secured by a distributed ledger technology algorithm. In some embodiments, step 1108 includes generating a transaction based on a computing rule to obtain a dataset associated with the secondary data address from a dataset received from the primary data address; and including in the transaction a message digest of the computing rule and an associated metadata.

Step 1110 includes forming an anonymized graph of relationships between data addresses supported by a distributed ledger network. In some embodiments, step 1110 includes revoking a permission to share a dataset associated with the primary data address with the secondary data address.

### Hardware Overview

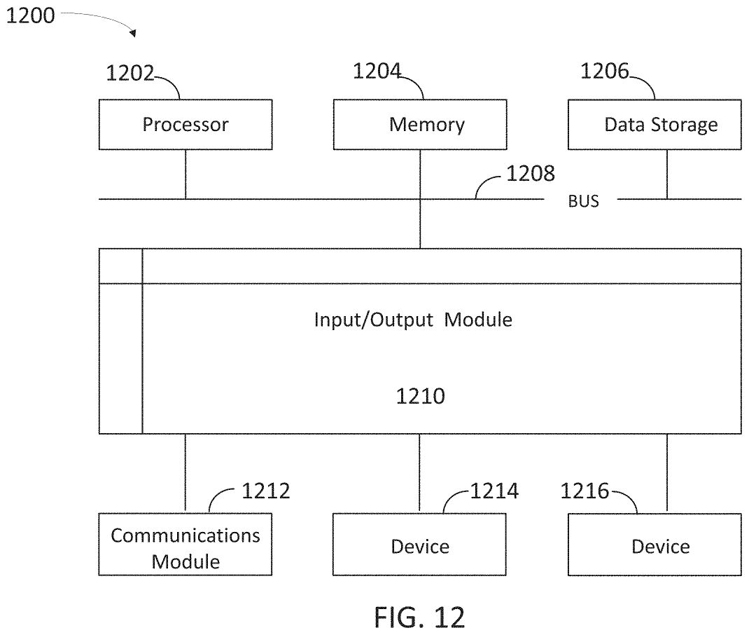

FIG. 12 is a block diagram illustrating an exemplary computer system 1200 with which the client device 110 and 210 and server 130 and 230 of FIGS. 1 and 2, and methods 600-1100 can be implemented. In certain aspects, the computer system 1200 may be implemented using hardware or a combination of software and hardware, either in a dedicated server, or integrated into another entity, or distributed across multiple entities.

Computer system 1200 (e.g., client device 110 and server 130) includes a bus 1208 or other communication mechanism for communicating information, and a processor 1202 (e.g., processors 212) coupled with bus 1208 for processing information. By way of example, the computer system 1200 may be implemented with one or more processors 1202. Processor 1202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1200 can include, in addition to hardware, code that creates an execution environment for the computer program in question, e.g., code that constitutes processor firmware, a protocol stack, a database management system, an operating system, or a combination of one or more of them stored in an included memory 1204 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 1208 for storing information and instructions to be executed by processor 1202. The processor 1202 and the memory 1204 can be supplemented by, or incorporated in, special purpose logic circuitry.

The instructions may be stored in the memory 1204 and implemented in one or more computer program products, e.g., one or more modules of computer program instructions encoded on a computer-readable medium for execution by, or to control the operation of, the computer system 1200, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1204 may also be used for storing temporary variable or other intermediate information during execution of instructions to be executed by processor 1202.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 1200 further includes a data storage device 1206 such as a magnetic disk or optical disk, coupled with bus 1208 for storing information and instructions. Computer system 1200 may be coupled via input/output module 1210 to various devices. Input/output module 1210 can be any input/output module. Exemplary input/output modules 1210 include data ports such as USB ports. The input/output module 1210 is configured to connect to a communications module 1212. Exemplary communications modules 1212 (e.g., communications modules 218) include networking interface cards, such as Ethernet cards and modems. In certain aspects, input/output module 1210 is configured to connect to a plurality of devices, such as an input device 1214 (e.g., input device 214) and/or an output device 1216 (e.g., output device 216). Exemplary input devices 1214 include a keyboard and a pointing device, e.g., a mouse or a trackball, by which a consumer can provide input to the computer system 1200. Other kinds of input devices 1214 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1216 include display devices, such as an LCD (liquid crystal display) monitor, for displaying information to the consumer.

According to one aspect of the present disclosure, the client device 110 and server 130 can be implemented using a computer system 1200 in response to processor 1202 executing one or more sequences of one or more instructions contained in memory 1204. Such instructions may be read into memory 1204 from another machine-readable medium, such as data storage device 1206. Execution of the sequences of instructions contained in main memory 1204 causes processor 1202 to perform the process steps described herein. One or more processors in a multi-processing arrangement may also be employed to execute the sequences of instructions contained in memory 1204. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical consumer interface or a Web browser through which a consumer can interact with an implementation of the subject matter described in this specification, or any combination of one or more such back-end, middleware, or front-end components. The components of the system can be inter-coupled by any form or medium of digital data communication, e.g., a communication network. The communication network (e.g., networks 150 and 250) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1200 can include clients and servers. A client and server are generally remote from each other and typically interact through a communication network. The relationship of client and server arises by virtue of computer programs running on the respective computers and having a client-server relationship to each other. Computer system 1200 can be, for example, and without limitation, a desktop computer, laptop computer, or tablet computer. Computer system 1200 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1202 for execution. Such a medium may take many forms, including, but not limited to, non-volatile media, volatile media, and transmission media. Non-volatile media include, for example, optical or magnetic disks, such as data storage device 1206. Volatile media include dynamic memory, such as memory 1204. Transmission media include coaxial cables, copper wire, and fiber optics, including the wires forming bus 1208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### RECITATION OF EMBODIMENTS

Embodiment I: A method includes creating a uniform resource identifier associated with a dataset, generating and storing a data access permission for the dataset in an immutable decentralized ledger with a distributed ledger technology, creating a metadata describing the dataset and enabling access to the metadata via the uniform resource identifier, receiving request from a client device to access a data subset associated with the dataset, verifying a digital credential of the client device using a secure authentication method, authorizing the request and confirming that the client device has a permission to access the dataset based on the distributed ledger technology, and providing multiple instructions and keys to the client device to access and retrieve the data subset.

Embodiment II: A method includes creating a dedicated server in a public cloud or a private data center to be used as a temporary location for a client device to access a requested data, generating a temporary identity key for the client device to access the requested data on a temporary server, providing the client device with instructions on how to access the requested data on the temporary server, receiving, in the temporary server, a request from the client device to access the requested data, verifying, in the temporary server, a digital credential of the client device using a secure authentication method, and providing, to the client device, the requested data stored on the temporary server.

Embodiment III: A method includes creating, with an asymmetric encryption algorithm, a public key and a private key, generating, with the public key, a unique sequence of symbols including a primary data address, signing, with the private key, a transaction that links the primary data address and a secondary data address, wherein the primary data address is associated with the public key, and the secondary data address is any other data address, adding the transaction to an immutable ledger of transaction secured by a distributed ledger technology algorithm, and forming an anonymized graph of relationships between data addresses supported by a distributed ledger network.

Embodiment IV: A system includes protocols, standards, processes, and systems, operating over a decentralized network. The system further includes a data sharing engine having a one or more distributed ledger technology nodes linked with nodes of data sharing engines installed by other participants to form a decentralized network, a directory tool that interacts with the one or more distributed ledger technology nodes to manage digital identities, authorizes a one or more data access requests, creates and updates a data point and their metadata, and manages a data point catalog, a scalable data storage that is used to keep a dataset associated with the data point, an encryption tool configured to generate encryption keys, encrypt data before storing them and decrypt it after retrieving data from the scalable data storage, an access tool configured to receive a request from a client device to access the data point, authenticate the client device, and validate permission to access the data, a request management tool configured to receive data from the client device and to store it in the scalable data storage, a request management tool configured to retrieve data from the scalable data storage and send it to the client device, and a website engine that interacts with the data sharing engine to enable clients to operate the system using a web browser.

In addition, embodiments I through IV may be combined with the below elements in any permutation and number.

Element 1, further including defining a data point that describes a dataset by combining its purpose, source, and format while disregarding its physical location, storage, access protocol, and content. Element 2, further including creating, for a data point, a unique virtual address and generating a uniform resource identifier using a scheme to enable a discovery and access the dataset by using a data access protocol. Element 3, wherein generating the metadata describing the dataset further includes specifying instructions on how to access the dataset using a data access protocol, wherein the instructions include a network address, and a data structure to retrieve the dataset. Element 4, further including creating a centralized catalog for multiple data points. Element 5, further including creating a de-centralized catalog for multiple data points. Element 6, further including: allowing a search query from a client device to discover a uniform resource identifier for a data point, and accessing, with a data address protocol, a metadata associated with the data point. Element 7, further including generating a virtual dataset that is at least partially computed as a result of processing information retrieved from one or several parent data sets. Element 8, further including: documenting, automating, and implementing an information processing stage, and allowing, with the information processing stage, a computation to be available for retrieving or to be used as a data source for a derivative data point. Element 9, further including: updating a state of a data sharing network with the distributed ledger technology and a smart contract, and registering access permission controlled by RBAC, ABAC, or any other policy-based access-control method. Element 10, further including maintaining an immutable log of transactions related to changing access permission and accessing data in a data point with the distributed ledger technology to maintain. Element 11, further including using the distributed ledger technology and an immutable log of transactions for: validating an end-to-end account of a provenance, an update, and a transformation of the dataset, and validating an end-to-end account of a provenance, an update, and a transformation of the dataset through a graph of a derivative data point. Element 12, further including forming a community network among multiple participants that share a data point and forming an anonymized graph of multiple datapoints including a derivative relationship and a data access state. Element 13, further including using data from an immutable log for: calculating a relative value of a contribution of a network participant to the data sharing and transformation process, and measuring, with a token, how much more the network participant contributes to a third-party network operation.

Element 14, further including encrypting a data subset with the temporary identity key and storing the requested data on the temporary server. Element 15, further including destroying the temporary server either immediately after the client device accesses the requested data or after a predefined time. Element 16, further including reusing a same temporary server to provide multiple clients with access to a same data assuming every client has verified permission to access this data subset.

Element 17, further including creating an association between a requested dataset and the primary data address. Element 18, further including allowing a share of a dataset associated with the primary data address with the secondary data address. Element 19, further including: generating a transaction that describes a dataset that has been copied from a data source associated with the primary data address to a destination associated with the primary data address, and including in the transaction a message digest of the data and an associated metadata. Element 20, further including generating a transaction based on a computing rule to obtain a dataset associated with the secondary data address from a dataset received from the primary data address; and including in the transaction a message digest of the computing rule and an associated metadata. Element 21, further including revoking a permission to share a dataset associated with the primary data address with the secondary data address.

Element 22, further including an application programming interface configured to communicatively couple the system with other data sharing engines, and by doing so, form a decentralized network of the data sharing engine. Element 23, wherein the data sharing engine further includes a data processing tool configured to compute a content of a derivative data point, using the dataset received from a parent data point. Element 24, further including a data bus communicatively coupling the data sharing engine and the website engine. Element 25, wherein the data sharing engine is a participant in: a distributed ledger technology network, and a consensus and replicates an immutable log of transactions. Element 26, further including a data sharing endpoint server configured to copy data from the client device to the data sharing engine or to copy data from the data sharing engine to the client device. Element 27, wherein the request management tool is also configured to create, update, and erase servers that are used as temporary data sharing endpoints of claim 15 to securely exchange data between the data sharing engine and the client device. Element 28, further including a directory tool that uses an application programming interface to collect information from other participants of the decentralized network and present it to the clients through the application programming interface or through a website.

What is claimed is:

1. A computer-implemented method, comprising:
creating a uniform resource identifier associated with a dataset;
generating and storing a data access permission for the dataset in an immutable decentralized ledger with a distributed ledger technology;
creating a metadata describing the dataset and enabling access to the metadata via the uniform resource identifier;
receiving a request from a client device to access a data subset associated with the dataset;
verifying a digital credential of the client device using a secure authentication method;
authorizing the request and confirming that the client device has a permission to access the dataset based on the distributed ledger technology; and
providing multiple instructions and keys to the client device to access and retrieve the data subset.

2. The computer-implemented method of claim 1, further comprising defining a data point that describes a dataset by combining its purpose, source, and format while disregarding its physical location, storage, access protocol, and content.

3. The computer-implemented method of claim 1, further comprising creating, for a data point, a unique virtual address and generating a uniform resource identifier using a scheme to enable a discovery and access the dataset by using a data access protocol.

4. The computer-implemented method of claim 1, wherein generating the metadata describing the dataset further comprises specifying instructions on how to access the dataset using a data access protocol, wherein the instructions include a network address, and a data structure to retrieve the dataset.

5. The computer-implemented method of claim 1, further comprising creating a centralized catalog for multiple data points.

6. The computer-implemented method of claim 1, further comprising creating a de-centralized catalog for multiple data points.

7. The computer-implemented method of claim 1, further comprising:
allowing a search query from a client device to discover a uniform resource identifier for a data point; and
accessing, with a data address protocol, a metadata associated with the data point.

8. The computer-implemented method of claim 1, further comprising generating a virtual dataset that is at least partially computed as a result of processing information retrieved from one or several parent data sets.

9. The computer-implemented method of claim 1, further comprising: documenting, automating, and implementing an information processing stage, and allowing, with the information processing stage, a computation to be available for retrieving or to be used as a data source for a derivative data point.

10. The computer-implemented method of claim 1, further comprising:
updating a state of a data sharing network with the distributed ledger technology and a smart contract; and
registering access permission controlled by RBAC, ABAC, or any other policy-based access-control method.

11. The computer-implemented method of claim 1 further comprises maintaining an immutable log of transactions related to changing access permission and accessing data in a data point with the distributed ledger technology to maintain.

12. The computer-implemented method of claim 1, further comprising using the distributed ledger technology and an immutable log of transactions for:
validating an end-to-end account of a provenance, an update, and a transformation of the dataset; and
validating an end-to-end account of a provenance, an update, and a transformation of the dataset through a graph of a derivative data point.

13. The computer-implemented method of claim 1, further comprising forming a community network among multiple participants that share a data point and forming an anonymized graph of multiple datapoints including a derivative relationship and a data access state.

14. The computer-implemented method of claim 1, further comprising using data from an immutable log for:
calculating a relative value of a contribution of a network participant to the data sharing and transformation process; and
measuring, with a token, how much more the network participant contributes to a third-party network operation.

15. A computer-implemented method, comprising:
creating a dedicated server in a public cloud or a private data center to be used as a temporary location for a client device to access a requested data;
generating a temporary identity key for the client device to access the requested data on a temporary server;
providing the client device with instructions on how to access the requested data on the temporary server;
receiving, in the temporary server, a request from the client device to access the requested data;
verifying, in the temporary server, a digital credential of the client device using a secure authentication method; and
providing, to the client device, the requested data stored on the temporary server.

16. The computer-implemented method of claim 15, further comprising:
encrypting a data subset with the temporary identity key and storing the requested data on the temporary server;
destroying the temporary server either immediately after the client device accesses the requested data or after a predefined time; and
reusing a same temporary server to provide multiple clients with access to a same data assuming every client has verified permission to access this data subset.

17. A system that includes protocols, standards, processes, and systems, operating over a decentralized network, comprising:
a data sharing engine, including:
a one or more distributed ledger technology nodes linked with nodes of data sharing engines installed by other participants to form a decentralized network;
a directory tool that interacts with the one or more distributed ledger technology nodes to manage digital identities, authorizes a one or more data access requests, creates and updates a data point and their metadata, and manages a data point catalog;
a scalable data storage that is used to keep a dataset associated with the data point;
an encryption tool configured to generate encryption keys, encrypt data before storing them and decrypt it after retrieving data from the scalable data storage;
an access tool configured to receive a request from a client device to access the data point, authenticate the client device, and validate permission to access the data;
a request management tool configured to receive data from the client device and to store it in the scalable data storage;
a request management tool configured to retrieve data from the scalable data storage and send it to the client device; and
a website engine that interacts with the data sharing engine to enable clients to operate the system using a web browser.

18. The system of claim 17, further comprising:
an application programming interface configured to communicatively couple the system with other data sharing engines, and by doing so, form a decentralized network of the data sharing engine; and
a data bus communicatively coupling the data sharing engine and the website engine.

19. The system of claim 17, further comprising:
a data sharing endpoint server configured to copy data from the client device to the data sharing engine or to copy data from the data sharing engine to the client device, and
a directory tool that uses an application programming interface to collect information from other participants of the decentralized network and present it to the clients through the application programming interface or through a website.

20. The system of claim 17, wherein:
the data sharing engine further comprises a data processing tool configured to compute a content of a derivative data point, using the dataset received from a parent data point,
the data sharing engine is a participant in:
a distributed ledger technology network, and
a consensus and replicates an immutable log of transactions, and
the request management tool is also configured to create, update, and erase servers that are used as temporary data sharing endpoints of claim 15 to securely exchange data between the data sharing engine and the client device.
